(19) United States
(12) Patent Application Publication
(10) Pub. No.: US 2023/0297699 A1
(43) Pub. Date: Sep. 21, 2023

(54) ACCESS RIGHT MANAGEMENT APPARATUS AND ACCESS RIGHT MANAGEMENT METHOD

(71) Applicant: Hitachi, Ltd., Tokyo (JP)

(72) Inventors: Yuya ISODA, Tokyo (JP); Yohsuke ISHII, Tokyo (JP); Keiko TANIGAWA, Tokyo (JP)

(73) Assignee: Hitachi, Ltd., Tokyo (JP)

(21) Appl. No.: 17/902,174

(22) Filed: Sep. 2, 2022

(30) Foreign Application Priority Data
Mar. 16, 2022 (JP) 2022-041331

(51) Int. Cl. G06F 21/60

(52) U.S. Cl. CPC G06F 21/604

(57) ABSTRACT

An access right management apparatus 1000, includes: a processor and a memory; and an indirect modification part 104 configured to: when first access right information is modified with a first modification content, the first access right information indicating an access right necessary for a first system to access an application, identify based on a predetermined database, second access right information indicating an access right necessary for a second system to access the application and having a relationship with the first access right information; convert the first modification content of the first access right information to a second modification content corresponding to the second access right information; and modify the identified second access right information with the second modification content.

### CROSS-REFERENCE TO RELATED APPLICATION

This application claims priority pursuant to Japanese patent application No. 2022-041331, filed on Mar. 16, 2022, the entire disclosure of which is incorporated herein by reference.

### BACKGROUND

### Technical Field

The present invention relates to an access right management apparatus and an access right management method.

### Related Art

In recent years, more business operators execute predetermined applications (applications on the cloud) through multiple cloud services for businesses (multi-cloud). Such applications are often updated to improve functionality and security. This might change the content of an access right necessary for access to applications from cloud services.

Currently, a user or an administrator using cloud services individually monitors updates of applications and changes the settings of information on access rights to the applications as needed, for example. However, monitoring application updates and changing the access right settings in such a manner is a burden on small organizations (companies, etc.), impeding the introduction of multi-cloud.

For example, U.S. Unexamined Patent Application Publication No. 2007/0277222 specification discloses proposing policy update by searching for and employing an existing policy based on a log. U.S. Unexamined Patent Application Publication No. 2020/0379753 specification discloses a technique to determine version control. (hierarchy management, branch) of the policy depending on the system configuration for automatic version control.

Those techniques in combination are possibly able to manage access rights by conducting version control for the root policy (initial settings) depending on the log, execution environment, or user and integrally managing the root policy and derived policy. However, this combination cannot integrally manage policies having no version or branch relationship. For example, the result of modifying a policy A cannot be reflected on an independent policy B. Those techniques also cannot provide a satisfactory mechanism that allows the user to control such reflection. The operation thereof will lack flexibility for the user.

The present invention was made in the light of the aforementioned background and an object thereof is to provide an access right management apparatus that properly sets an access right of each of multiple systems executing an application and an access right management method therefor.

### SUMMARY

An aspect of the present invention to solve the above object is an access right management apparatus, comprising: a processor and a memory; and an indirect modification part configured to: when first access right information is modified with a first modification content, the first access right information indicating an access right necessary for a first system to access an application, identify based on a predetermined database, second access right information indicating an access right necessary for a second system to access the application and having a relationship with the first access right information; convert the first modification content of the first access right information to a second modification content corresponding to the second access right information; and modify the identified second access right information with the second modification content.

According to the present invention, it is possible to properly set an access right of each of multiple systems executing an application.

The problems, configurations, and effects other than those described above are revealed by the following description of an embodiment.

### BRIEF DESCRIPTION OF DRAWINGS

FIG. 1 is a diagram for explaining a configuration example of an access right management system according to an embodiment.

FIG. 2 is a diagram for explaining examples of hardware and functions provided for a system management apparatus.

FIG. 3 is a diagram illustrating an example of execution management information.

FIG. 4 is a diagram illustrating another example of the execution management information.

FIG. 5 is a diagram illustrating an example of right information.

FIG. 6 is a diagram illustrating an example of operation information.

FIG. 7 is a diagram illustrating an example of conversion information.

FIG. 8A is a diagram illustrating a content example represented by the conversion information concerning direct modification.

FIG. 8B is a diagram illustrating a content example represented by the conversion information concerning direct modification.

FIG. 8C is a diagram illustrating a content example represented by the conversion information concerning direct modification.

FIG. 9 is a diagram illustrating a content example represented by the conversion information concerning indirect modification.

FIG. 10 is a diagram illustrating an example of right modification control information.

FIG. 11 is a diagram illustrating an example of right modification result information.

FIG. 12 is a diagram illustrating an example of knowledge information.

FIG. 13 is a diagram illustrating an example of conversion prohibition information.

FIG. 14 is a diagram illustrating an example of modification process prohibition information.

FIG. 15 is a flowchart for explaining an outline example of a process executed by an access right management apparatus.

FIG. 16 is a diagram illustrating an example of an execution management screen.

FIG. 17 is a flowchart for explaining an example of a direct modification process.

FIG. 18 is a diagram illustrating an example of a direct modification proposition screen.

FIG. 19 is a flowchart for explaining an example of an indirect modification process.

FIG. 20 is a diagram illustrating an example of an indirect modification proposition screen.

FIG. 21 is a flowchart for explaining an example of a user response acceptance process.

FIG. 22 is a diagram illustrating an example of a right modification result management screen.

FIG. 23 is a flowchart for explaining an example of a reuse process.

### DETAILED DESCRIPTION OF EMBODIMENTS

Hereinafter, an embodiment of the present invention will be described.

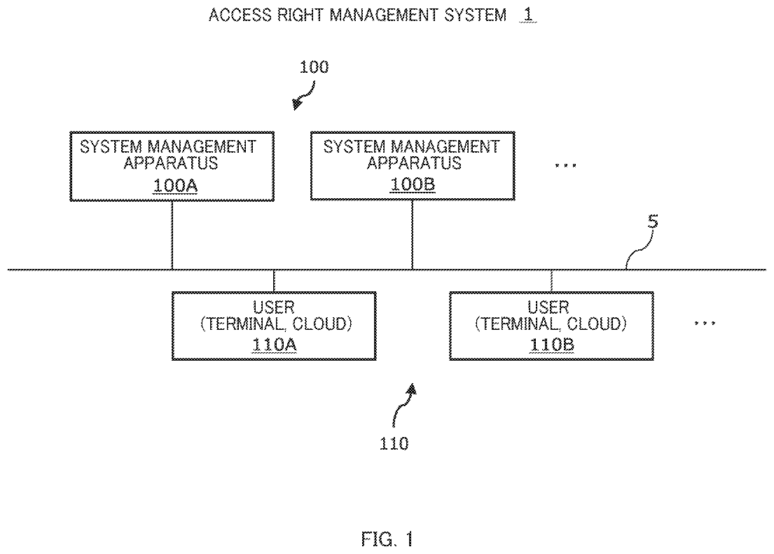

FIG. 1 is a diagram for explaining a configuration example of an access right management system 1 according to the embodiment. The access right management system 1 includes at least one system management apparatus 100 (100A, 100B, . . . ) and at least one user system 110 (110A, 110B, . . . ).

The system management apparatus 100 stores a later-described program 2030 (an application).

Each user system 110 is an information processing system used by a user utilizing an application. The user system 110 calls and executes an application of the system management apparatus 100. The user system 110 may be composed of an information processing apparatus (a so-called on-premises), such as a server apparatus, managed by a user himself/herself or may be an information processing system that operates in conjunction with an information processing service (a so-called cloud service) on a network managed by a business operator other than the user. To access the application, it is necessary to previously set in association with the application, proper access right information (hereinafter, referred to as right information and described later in detail) that is different for each user system 110.

Each system management apparatus 100 and each user system 110 are able to communicate with each other through a wired or wireless communication network 5, for example, such as the Internet, a local area network (LAN), a wide area network (WAN), or a dedicated line.

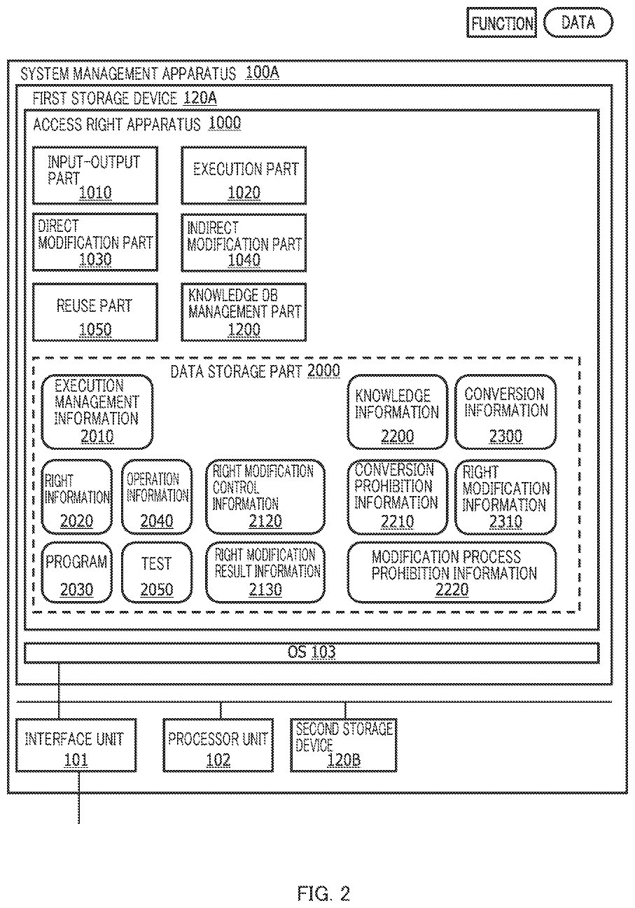

FIG. 2 is a diagram for explaining examples of hardware and functions included in the system management apparatus 100. The system management apparatus 100 includes the following hardware: a processor unit 102, a first storage device 120A, an interface unit 101, and a second storage device 120B.

The processor unit 102 is composed of a central processing unit (CPU), a digital signal processor (DSP), a graphics processing unit (GPU), a field-programmable gate array (FPGA), and the like. The first and second storage devices 120A and 120B are composed of memories, such as a read only memory (ROM), a random access memory (RAM), a hard disk drive (HDD), or a solid state drive (SSD). The interface unit 101 is composed of a network interface card (NIC), a wireless communication module, a universal serial interface (USB) module, a serial communication module, or the like. The system management apparatus 100A includes an input device composed of a mouse, a keyboard, or the like and an output device composed of a liquid-crystal display, an organic electro-luminescence (EL) display, or the like, which are not illustrated.

Next, the system management apparatus 100 includes functions implemented by an access right management apparatus 1000 and an OS 103 stored in the first storage device 120A. The access right management apparatus 1000 is a virtual information processing apparatus, such as a virtual machine or a container.

The access right management apparatus 1000 includes functional parts (programs): an input-output part 1010, an execution part 1020, a direct modification part 1030, an indirect modification part 1040, a reuse part 1050, a knowledge DB management part 1200, and a data storage part 2000.

The input-output part 1010 displays a predetermined screen or accepts an input of data from a user. For example, the input-output part 1010 displays conversion information.

The execution part 1020 accesses and executes the program 2030 described later.

The direct modification part 1030 modifies right information 2020 representing an access right necessary for a certain user system 110 to access an application of the system management apparatus 100, based on operation information 2040. The operation information 2040 is log or error information outputted from the execution part 1020. This modification is referred to as direct modification below.

When right information 2020 is subjected to direct modification, the indirect modification part 1040 identifies other right information 2020 that indicates an access right necessary for another user system 110 to access the same application and is related to the right information 2020 subjected to direct modification, based on knowledge information 2200 (described later). The indirect modification part 1040 converts the content of modification of the right information 2020 subjected to the direct modification into a content of modification corresponding to the aforementioned another user system 110 based on conversion information 2300 (described later) and modifies the identified right information 2020 with the content of modification obtained by the conversion. This modification is referred to as indirect modification below.

The reuse part 1050 accepts specification of an application from the user in a predetermined display screen. When the application is specified, the reuse part 1050 displays a program that can access the specified application and access right information based on a history of modification or the like.

The knowledge DB management part 1200 manages the later-described knowledge information 2200.

The data storage part 2000 stores various types of data. Specifically, the access right management apparatus 1000 stores databases: execution management information 2010, the right information 2020, the program 2030, the operation information 2040, a test program 2050, right modification control information 2120, right modification result information 2130, the knowledge information 2200, the conversion information 2300, conversion prohibition information 2210, right modification information 2310, and modification process prohibition information 2220.

The execution management information 2010 is information that stores processing executed by the access right management apparatus 1000 for the program 2030 and the order of execution thereof. The access right management apparatus 1000 executes each process according to the execution management information 2010.

The right information 2020 is information that defines an access right (hereinafter, referred to as just an access right) necessary for the user system 110 to execute the program 2030.

The program 2030 is a program of an application used in work by users (for example, a virtual machine (VM) or a container application).

The operation information 2040 is information outputted during or at the end of execution of the program 2030 (the application). The operation information 2040 contains information on an access right-related error that occurred during the program 2030 (information indicating a lack of access right necessary to execute the program 2030, for example).

The test program 2050 is a program that when the program 2030 (the application) is updated with a predetermined updating program, verifies whether the updated program 2030 operates normally. When the program 2030 is updated, the access right necessary to execute the program 2030 is changed in some cases, which requires modification of the right information 2020.

The right modification control information 2120 is information that defines the procedure to modify the right information 2020, including whether to inquire the user system 110 in advance to execute modification (direct modification and indirect modification) for the right information 2020 or not.

The right modification result information 2130 is information on modification of right information 2020.

The knowledge information 2200 is information storing attribute information of information (referred to as components hereinafter) associated with access rights, including the user (the user system 110), the program 2030, the right information 2020, the operation information 2040, and the right modification information 2310. The knowledge information 2200 is used to estimate the strength of the relationship (the similarity, etc.) between components.

The conversion information 2300 stores conversion rules (conversion patterns) used to convert the content of modification for right information 2020 to a content of modification in another format. The conversion rules include an initial, conversion rule as a conversion rule for direct modification and a conversion rule for indirect modification.

The conversion prohibition information 2210 is information storing a conversion pattern that is not proposed to the user as described later. In the embodiment, the conversion prohibition information 2210 defines a user to whom the conversion pattern is not applied. However, the conversion prohibition information 2210 may define other information.

The right modification information 2310 is information storing modified right information 2020.

The modification process prohibition information 2220 is information storing a pattern (hereinafter, referred to as a conversion prohibited pattern) of right information 2020 before conversion and right information 2020 after conversion which prohibits conversion (modification) for the right information 2020.

The hardware and functions described above are similarly provided for the other system management apparatuses 100 (100B, 100C, . . . ).

Next, specific data examples stored in the data storage part 2000 will be described.

### (Execution Management Information)

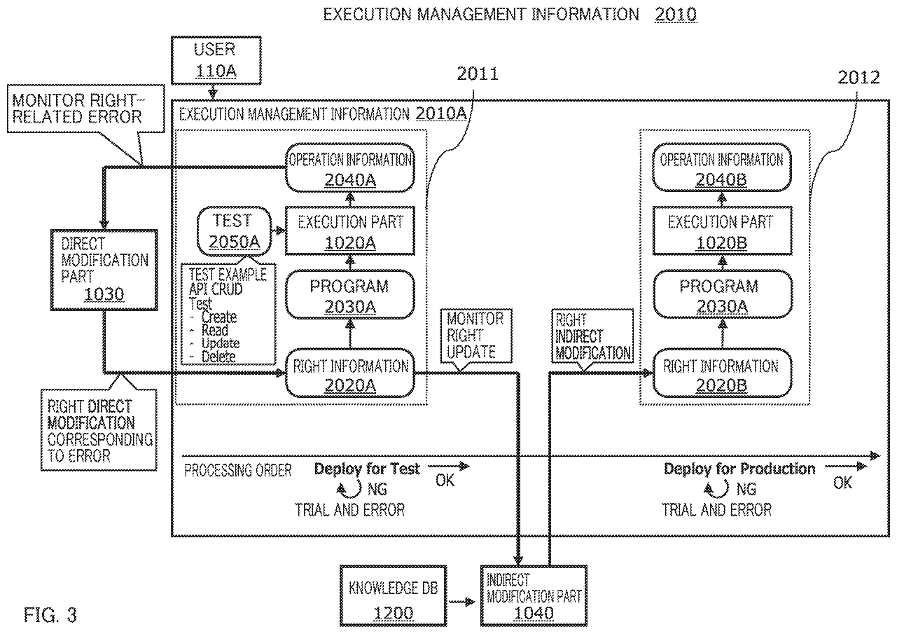

FIG. 3 is a diagram illustrating an example of the execution management information 2010. This execution management information 2010A is execution management information 2010 managed by the first user system 110A. The execution management information 2010A includes test phase information 2011 as information on the processing for test execution of the program 2030 (the application) and production phase information 2012 as information on the processing for production execution of the program 2030.

The test phase information 2011 includes information indicating conduction of processes to set the right information 2020A at a program 2030A, read a test program 2050A, perform test execution of the program 2030A using the test program 2050A, and create operation information 2040A by the test execution.

The direct modification part 1030 monitors creation of the operation information 2040A as needed and modifies the right information 2020A based on the created operation information 2040A and knowledge DB management part 1200 (direct modification). The indirect modification part 1040 monitors direct modification for the right information 2020A and when detecting the direct modification based on the operation information 2040A, modifies other right information 2020B related to the operation information 2040A based on the operation information 2040A and knowledge DB management part 1200 (indirect modification).

The production phase information 2012 includes information indicating conduction of the processes to set at the program 2030A, the right information 2020B subjected to the indirect modification, execute the program 2030A, and acquire operation information 2040B by the execution.

As described above, the execution management information 2010 of the example is management information when the same user uses the same program 2030A in different information processing systems (system environments), which are a test execution system (a first system) and a production execution system (a second system), and the information processing systems respectively use the right information 2020A and right information 2020B, which are different from each other, for the program 2030A. That is, the access right modified in the development system can be reflected onto the access right in the production system.

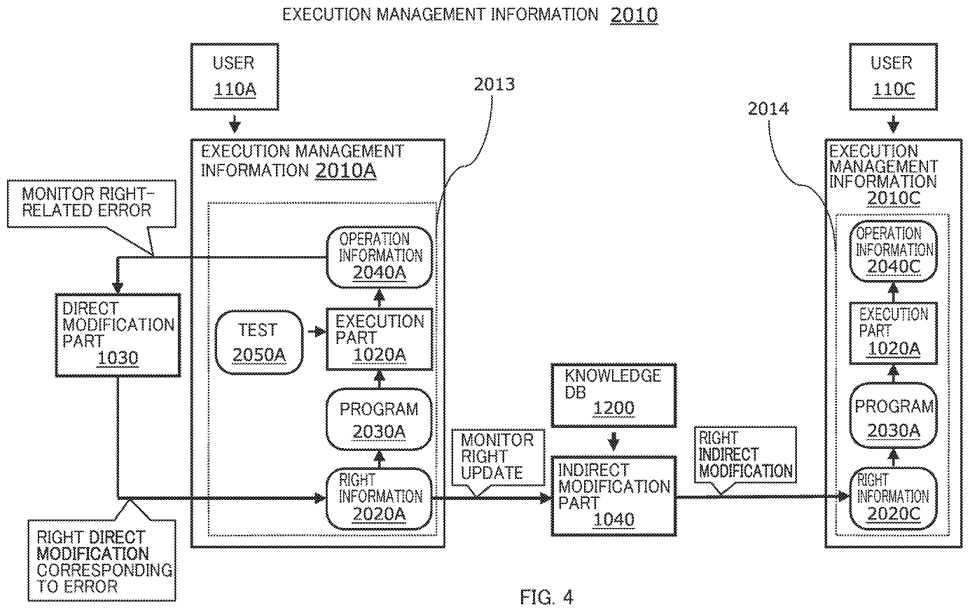

Next, FIG. 4 is a diagram illustrating another example of the execution management information 2010. The execution management information 2010 is composed of the execution management information 2010A (test execution phase information 2013) managed by the first user system 110A and execution management information 2010C (production execution phase information 2014) managed by the second user system 110C.

The execution management information 2010A includes information indicating conduction of processes to set the right information 2020A at the program 2030A, read the teat program 2050A, perform test execution of the program 2030A using the test program 2050A, and acquire the operation information 2040A by the test execution. Direct modification and indirect modification are performed in the same manner as described above (direct modification is performed for the right information 2020A while indirect modification is performed for other right information 2020C related to the right information 2020A).

The execution management information 2010C includes information indicating conduction of processes to set at the program 2030A, the right information 2020C subjected to the indirect modification, execute the program 2030A, and acquire operation information 2040C by the execution.

As described above, the execution management information 2010 is applicable in the case where different users use the same program 2030A in different processing systems (system environments), which are the test execution system (the first system) and the production execution system (the second system), and the different processing systems use the respective right information 2020A and right information 2020C, which are different from each other, for the program 2030A.

As described above, the execution management information 2010 is applicable in the case where multiple systems access the same application, independent of the number of users or the program development line configuration (continuous integration/continuous delivery (CI/CD)).

### (Right Information)

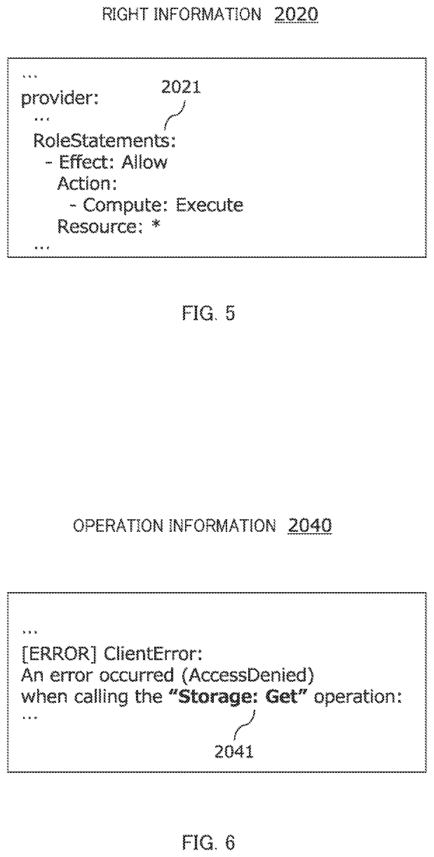

Next, FIG. 5 is a diagram illustrating an example of right information 2020. This right information 2020 includes a field 2021 concerning an access right.

### (Operation Information)

FIG. 6 is a diagram illustrating an example of operation information 2040. This operation information 2040 includes a field 2041 for information on an access right-related error that occurred during execution of the program 2030.

### (Conversion Information)

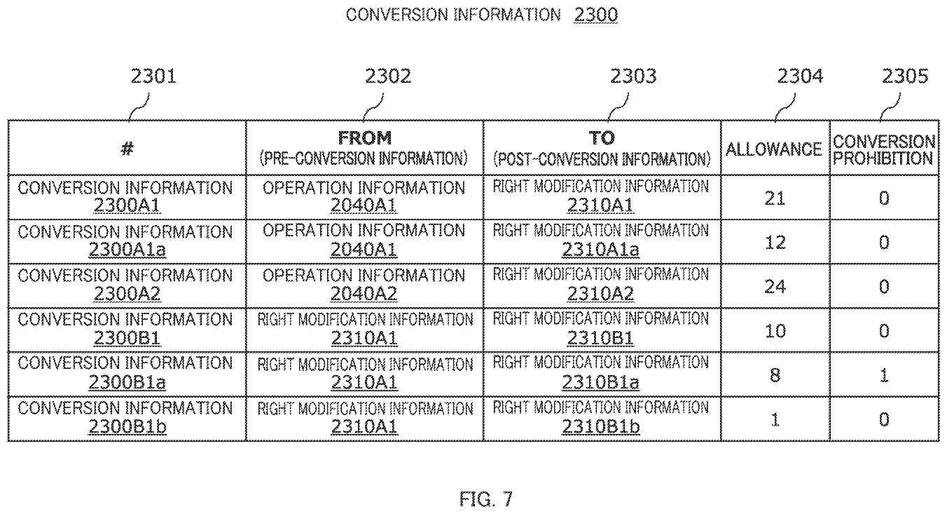

FIG. 7 is a diagram illustrating an example of conversion information 2300. The conversion information 2300 is composed of at least one record containing data items: Number 2301, Pre-conversion information 2302, Post-conversion information 2303, Allowance 2304, and Conversion Prohibition 2305. Number 2301 is set to the number of a conversion pattern. Pre-conversion information 2302 is set to information (hereinafter, referred to as pre-conversion information) containing information of an access right before conversion in the conversion pattern. Post-conversion information 2303 is set to information (hereinafter, referred to as post-conversion information) containing information on an access right modified based on the information concerning Pre-conversion information 2302. Allowance 2304 is set to information on the number of user inputs to specify allowance of conversion based on the conversion pattern (hereinafter, referred to as a user allowance input and described in detail later). Conversion Prohibition 2305 is set to information on the number of user inputs to specify prohibition of current and future conversion based on the conversion pattern (hereinafter, referred to as a user conversion prohibition input and described in detail later).

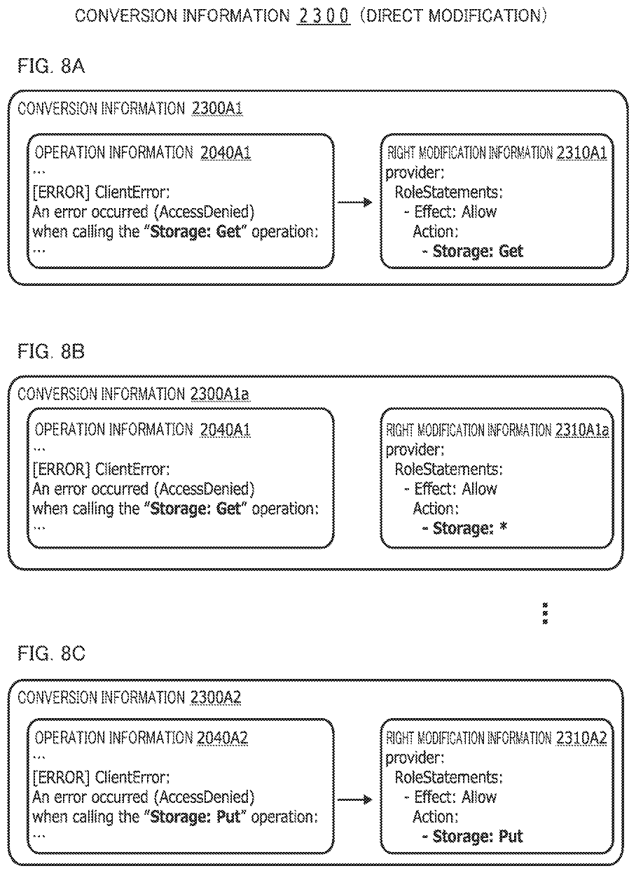

FIGS. 8A-C is a diagram illustrating content examples represented by conversion information 2300 concerning direct modification. Conversion information 2300A1 illustrated in FIG. 8A is information on a conversion pattern in which right information 2020 identified based on the operation information 2040 is modified without any change in format. That is, the conversion information 2300M is information on a conversion pattern in which addition of an access right (“Storage:Get”) in a certain description format is directly applied as a content of modification to the right information 2020 to create right modification information 2310A1 as modified (converted) right information.

Conversion information 2300A1a illustrated in FIG. 8B is information on a conversion pattern in which the format is not changed and the user modifies the content. That is, the conversion information 2300A1a is information on a conversion pattern in which addition of an access right (“Storage:Get”) in a certain description format and modification (modification by the user) from “Get” to “*” in the “Storage:Get” are applied together as the content of modification to the right information 2020 before conversion to create right modification information 2310A1a as modified (converted) right information.

Conversion information 2300A2 illustrated in FIG. 8C is information on a conversion pattern in which the format is not changed and the user does not modify the content. That is, the conversion information 2300A2 is information on a conversion pattern in which addition of an access right (“Storage:Put”) in a certain description format in the pre-conversion information is directly applied as the content of modification to the right information 2020 before conversion to create right modification information 2310A2 as modified (converted) right information.

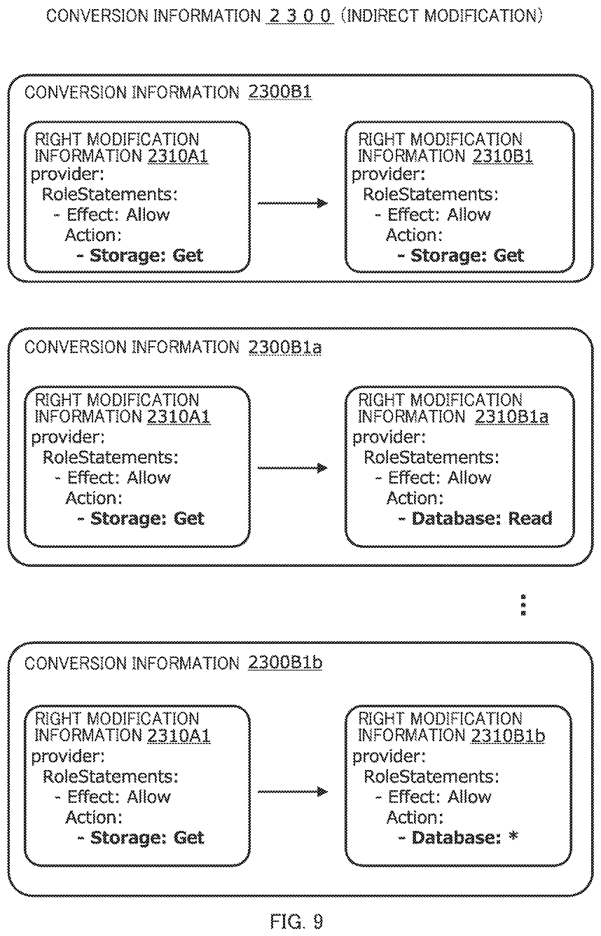

FIG. 9 is a diagram illustrating examples of the conversion information 2300 concerning indirect modification. Conversion information 2300B1 illustrated in FIG. 9 is information on a conversion pattern in which the format is not changed and the content is not modified by the user. That is, the conversion information 2300B1 is information on a conversion pattern in which addition of an access right (“Storage:Get”) in a certain description format in the right modification information 2310A1 as the pre-conversion information is directly applied as the content of modification to the right information 2020 before conversion to create right modification information 2310B1 as modified (converted) right information.

Conversion information 2300B1a illustrated in FIG. 9 is information on a conversion pattern in which the format is changed and the content is not changed. That is, the conversion information 2300B1a is information on a conversion pattern in which conversion of an access right (“Storage:Get”) in a certain description format in the right modification information 2310A1 as the pre-conversion information to an access right 2300B1a (“Database:Read”) that has the same meaning as that in the right modification information 2310A1 in a different description format is applied as the content of modification to the right information 2020 before conversion to create right modification information 2310B1a as modified (converted) right information. The reason why the formats are different is because the user systems 110 employ different ways to describe the files of the right information 2020, for example.

Conversion information 2300B1b illustrated in FIG. 9 is information on a conversion pattern in which the format is changed and the content is modified by the user. That is, the conversion information 2300B1b is information on a conversion pattern in which conversion of an access right (“Storage:Get”) in a certain description format in the right modification information 2310A1 as the pre-conversion information to an access right (“Database:Read”) that has the same meaning as that in the right modification information 2310A1 in a different description format and modification (modification by the user) from “Read” to “*” in the right modification information 2310A1 are applied together as the content of modification to the right information 2020 before conversion to create right modification information 2310B1b as modified (converted) right information.

In such a manner, the conversion information 2300 stores the content of conversion from right information 2020 before conversion to right information 2020 after conversion and a change in format at the conversion.

### (Right Modification Control Information)

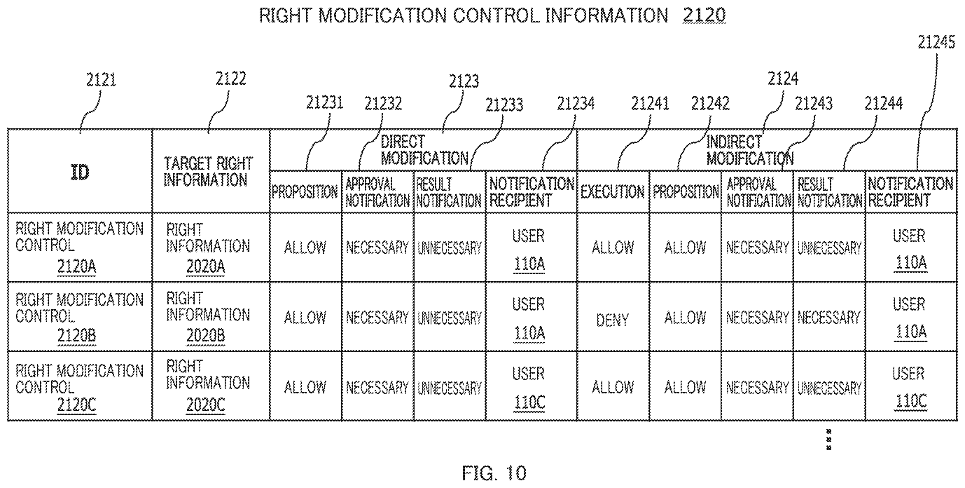

FIG. 10 is a diagram illustrating an example of the right modification control information 2120. The right modification control information 2120 is composed of at least one record containing data items: ID 2121, Target Right Information 2122, Direct Modification 2123, and Indirect Modification 2124. ID 2121 is set to identifier information of a modification procedure for right information 2020; Target Right Information 2122, the right information 2020 as a target for modification in the modification procedure of interest; Direct Modification 2123, information identifying the procedure of direct modification for the right information 2020; and Indirect Modification 2124, information identifying the procedure of indirect modification for the right information 2020.

Direct Modification 2123 includes data sub-items: Proposition 21231, Approval Notification 21232, Result Notification 21233, and Notification Recipient 21234. Proposition 21231 is set to determination information (“allow” or “deny”) indicating whether to give the user a proposition of direct modification for the right information 2020 concerning Target Right Information 2122 (proposition to the user); Approval Notification 21232, information (“necessary” or “unnecessary”) indicating whether it is necessary to make a notification (an approval notification) that causes the user to confirm and select whether to execute direct modification for the right information 2020 concerning Target Right Information 2122; Result Notification 21233, information (“necessary” or “unnecessary”) indicating whether it is necessary to notify the user of the result from the direct modification performed for the right information 2020 concerning Target Right Information 2122 (result notification); Notification recipient 21234, information identifying the user system 110 (the creator of the right information 2020, for example) that is to be notified of the result.

Indirect Modification 2124 includes data sub-items: Execution 21241, Proposition 21242, Approval Notification 21243, Result Notification 21244, and Notification Recipient 21245. Execution 21241 is set to determination information indicating whether to allow execution of indirect modification for the right information 2020 concerning Target Right Information 2122; Proposition 21242, information (“allow” or “deny”) indicating whether to propose to the user, indirect modification for the right information 2020 concerning Target Right Information 2122 (proposition to the user); Approval Notification 21243, information (“necessary” or “unnecessary”) indicating whether it is necessary to make an approval notification of indirect modification for the right information 2020 concerning Target Right Information 2122; Result Notification 21244, information (“necessary” or “unnecessary”) indicating whether it is necessary to make a result notification of indirect modification for the right information 2020 concerning Target Right Information 2122; and Notification Recipient 21245, information identifying the user system 110 that is to be notified of the result. When no data are set in the data sub-items, the sub-items may be considered to be “deny” or “necessary”.

### (Right Modification Result Information)

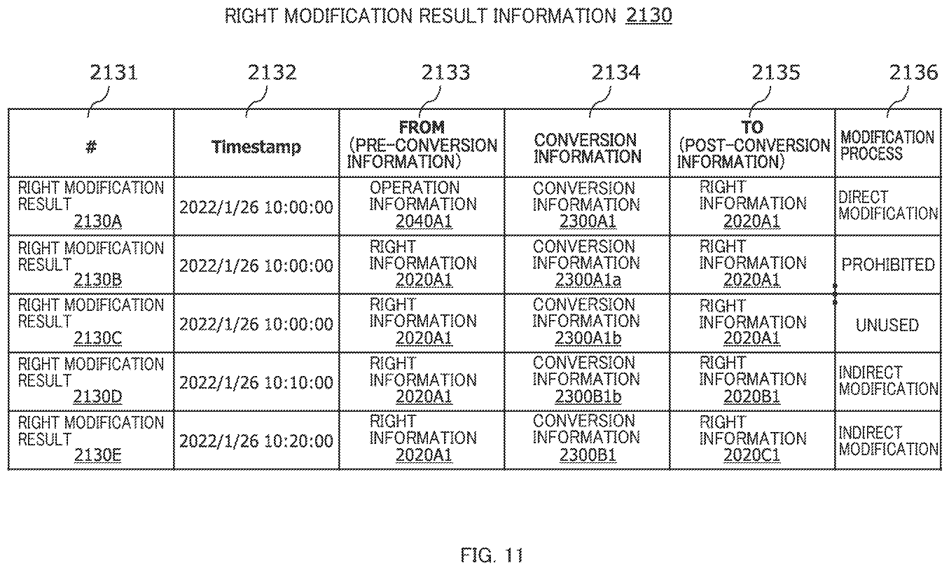

FIG. 11 is a diagram illustrating an example of the right modification result information 2130. The right modification result information 2130 contains data items: Number 2131, Time Stamp 2132, Pre-conversion Information 2133, Conversion Information 2134, Post-conversion Information 2135, and Modification Process 2136. Number 2131 is set to identifier information of modification; Time Stamp 2132, information on the time when the modification of interest was performed; Pre-conversion Information 2133, the pre-conversion information as the target for conversion based on the conversion pattern used in the modification; Conversion information 2134, a conversion pattern used in the modification; Post-conversion Information 2135, post-conversion information after the conversion based on the conversion pattern used in the modification; and Modification Process 2136, the procedure type of the modification. Modification Process 2136 is set to “direct modification”, “indirect modification”, “prohibited” (the modification was proposed to the user but a user conversion prohibition input was made), or “unused” (the modification was proposed to the user but was not selected by the user, which is referred to as user unspecified. The details thereof are described later), for example.

### (Knowledge Information)

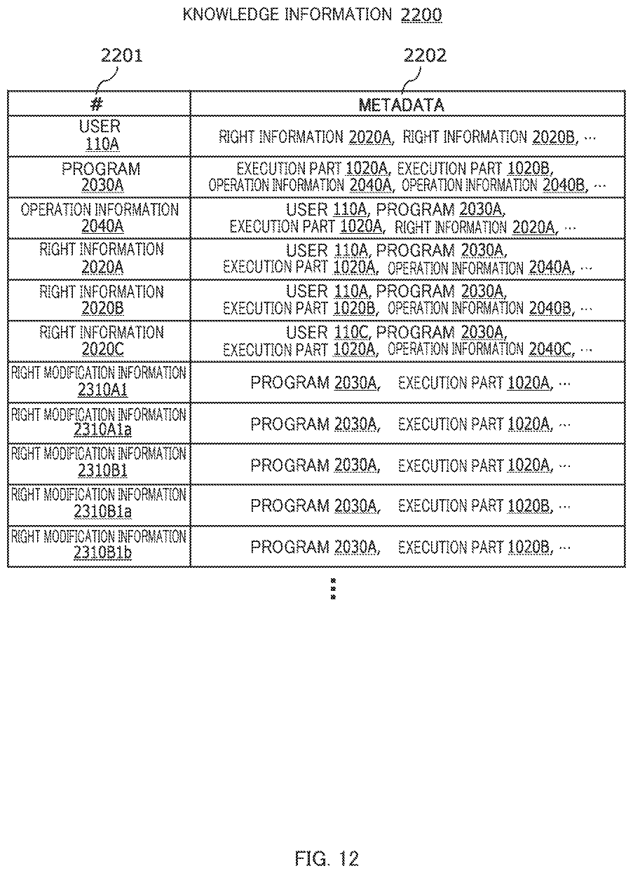

FIG. 12 is a diagram illustrating an example of the knowledge information 2200. The knowledge information 2200 is composed of at least one record containing data items: Number 2201 and Metadata 2202. Number 2201 is set to identifier information of each component; and Metadata 2202 is set to attribute information of the component. Metadata 2202 contains at least one piece of information on the component or at least one piece of attribute information characterizing the component.

### (Conversion Prohibition Information)

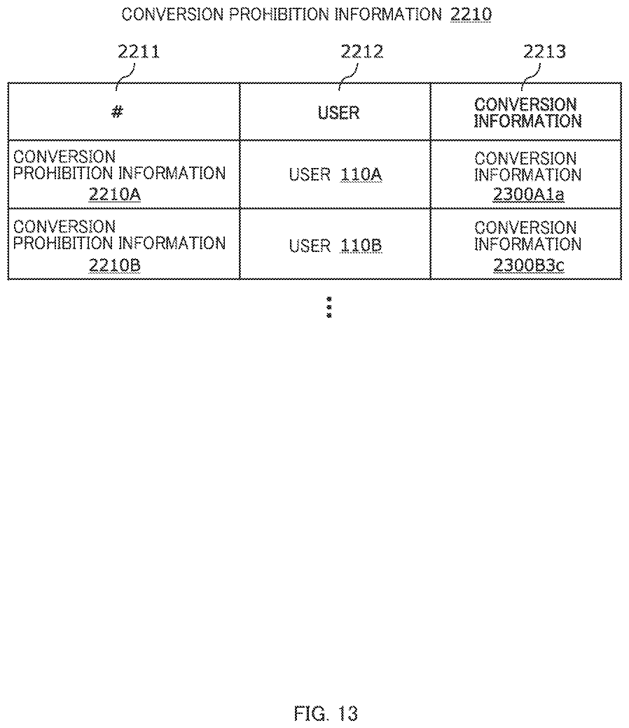

FIG. 13 is a diagram illustrating an example of conversion prohibition information 2210. The conversion prohibition information 2210 is composed of at least one record containing data items: Number 2211, User 2212, and Conversion Information 2213. Number 2211 is set to identifier information of a conversion pattern; User 2212, information on a user to which the conversion of right information 2020 based on the conversion pattern of interest is not proposed; and Conversion Information 2213, information (specifically, conversion information 2300) identifying the conversion not proposed to the user.

### (Modification Process Prohibition Information)

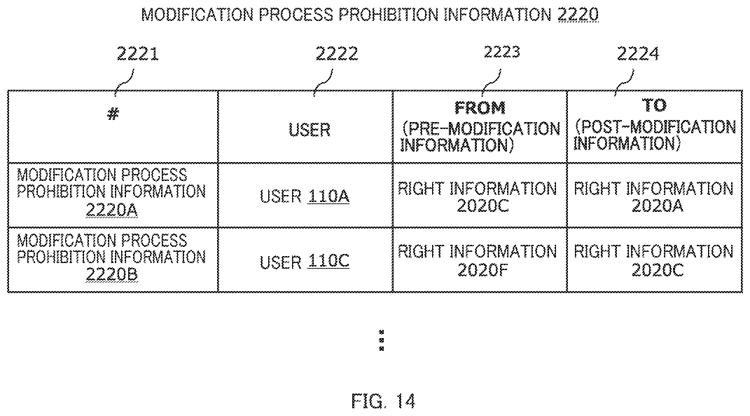

FIG. 14 is a diagram illustrating an example of modification process prohibition information 2220. The modification process prohibition information 2220 includes at least one record containing data items: Number 2221, User 2222, Pre-modification Information 2223, and Post-modification Information 2224. Number 2221 is set to the number of a conversion prohibited pattern; User 2222, information on the user to which the conversion prohibited pattern is applied; Pre-modification Information 2223, information identifying the right information 2020 before conversion or the operation information 2040 in the conversion prohibited pattern; and Post-modification Information 2224, information identifying the right information 2020 after conversion in the conversion prohibited pattern.

In the example of FIG. 14, modification from the right information 2020C to the right information 2020A is prohibited for the first user system 110A. This is because the content of the right information 2020C is not reliable for example (in the case where the right information 2020C was created by an unskilled user, and the like), and allowing the modification from the right information 2020C of poor reliability can inhibit proper access right management currently and in future.

The functions of the system management apparatus 100 described above are implemented by the processor unit 102 reading and executing a program stored in each storage device 120. The above program can be recorded in a recording medium for distribution, for example. All of or part of each information processing apparatus may be implemented using a virtual information processing resource provided by a virtualization technique, a process space isolation technique, or the like, like a virtual server provided by a cloud system, for example. All of or part of the functions provided by each information processing apparatus may be implemented by a service provided by a cloud system via an application programming interface (API) or the like, for example. Each user system 110 is also implemented by a processing device thereof reading and executing a predetermined program stored in a storage device.

Next, processing executed by the system management apparatus 100 (specifically, the access right management apparatus 1000) will be described.

### <Outline of Process>

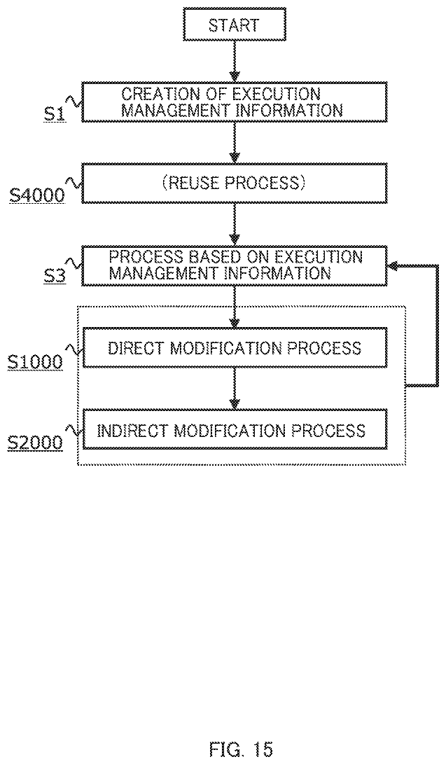

FIG. 15 is a flowchart for explaining an outline example of processes executed by the access right management apparatus 1000.

First, the access right management apparatus 1000 executes an execution information management process s1 that accepts as needed an input of the execution management information 2010 from a user (hereinafter, referred to as a present user) utilizing the access right management apparatus 1000. When specification of the program 2030 in the execution management information 2010 is accepted from the user, the reuse part 1050 executes a reuse process s4000 that displays the latest right information 2020 used for the specified program 2030 as a proposition.

The access right management apparatus 1000 executes an application execution process s3 that executes processes of an application using right information 2020, in accordance with the execution management information 2010 inputted in the execution information management process s1. The access right management apparatus 1000 creates or updates the operation information 2040 by this process.

On the other hand, when the application execution process s3 is started, the access right management apparatus 1000 executes a direct modification process s1000 as needed. Specifically, the access right management apparatus 1000 monitors creation or update of the operation information 2040. When the operation information 2040 is created or updated, the access right management apparatus 1000 identifies right information 2020 (hereinafter, referred to as direct modification target right information; first access right information) which was used in the application execution process s3 and corresponds to the information on the access right described in the created or updated operation information 2040 (information on the access right represented as error information) and performs direct modification for the identified direct modification target right information.

Furthermore, when the application execution process s3 is started, the access right management apparatus 1000 executes an indirect modification process s2000 as needed. Specifically, the access right management apparatus 1000 monitors direct modification. When direct modification is performed for right information 2020 (the first access right information), based on that right information 2020, the access right management apparatus 1000 identifies other right information 2020 (hereinafter, referred to as indirect modification target right information; second access right information) having a certain relationship with the right information 2020 of interest and performs indirect modification for the identified right information 2020. The access right management apparatus 1000 may further perform indirect modification for the right information 2020 already subjected to indirect modification.

Hereinafter, the execution information management process s1, reuse process s4000, direct modification process s1000, and indirect modification process s2000 will be described in detail.

### <Execution Information Management Process and Execution Management Screen>

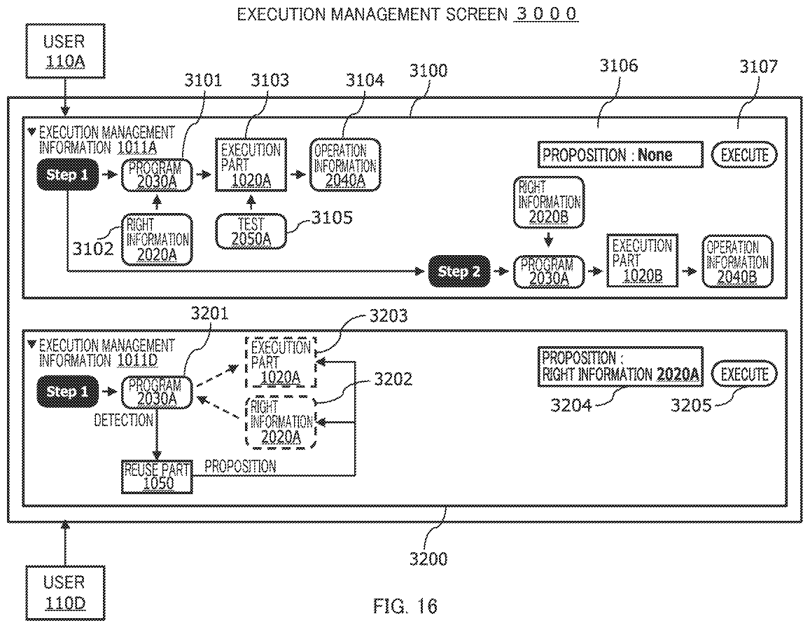

FIG. 16 is a diagram illustrating an execution management screen example displayed by the input-output part 1010 in the execution information management process s1. This execution management screen 3000 includes a first screen 3100 as a management screen for processing (test processing) managed by the first user system 110A among the execution management information 2010 and a second screen 3200 as a management screen for processing (production processing) managed by the user system 110D among the execution management information 2010.

The first screen 3100 includes: a program specifying field 3101, a right information specifying field 3102, an execution part specifying field 3103, an operation information specifying field 3104, a test specifying field 3105, a right information proposition field 3106, and an execution specifying field 3107. The program specifying field 3101 accepts specification of the program 2030 from the user. The right information specifying field 3102 accepts specification of the right information 2020 for the program 2030 from the user. The execution part: specifying field 3103 accepts specification of the execution part 1020 intended to execute the program 2030. The operation information specifying field 3104 accepts from the user, specification of the output location of the operation information 2040 outputted upon execution of the program 2030. The test specifying field 3105 accepts from the user, specification of the test program 2050 used to test the program 2030 in the execution part 1020. The right information proposition field 3106 displays as a proposition, right information 2020 that is suitable for the program 2030 specified by the user in the program specifying field 3101. The execution specifying field 3107 accepts an instruction to start execution of the application execution process s3 from the user.

The second screen 3200 includes: a program specifying field 3201, a right information specifying field 3202, an execution part specifying field 3203, a right information proposition field 3204, and an execution specifying field 3205. The program specifying field 3201 accepts specification of the program 2030 from the user. The right information specifying field 3202 accepts specification of the right information 2020 for the program 2030 from the user. The execution part specifying field 3203 accepts specification of the execution part 1020 intended to execute the program 2030 from the user. The right information proposition field 3204 displays as a proposition, right information 2020 that is suitable for the program 2030 specified by the user in the program specifying field 3201. The execution specifying field 3205 accepts an instruction to start execution of the application execution process s3 from the user.

### <Direct Modification Process>

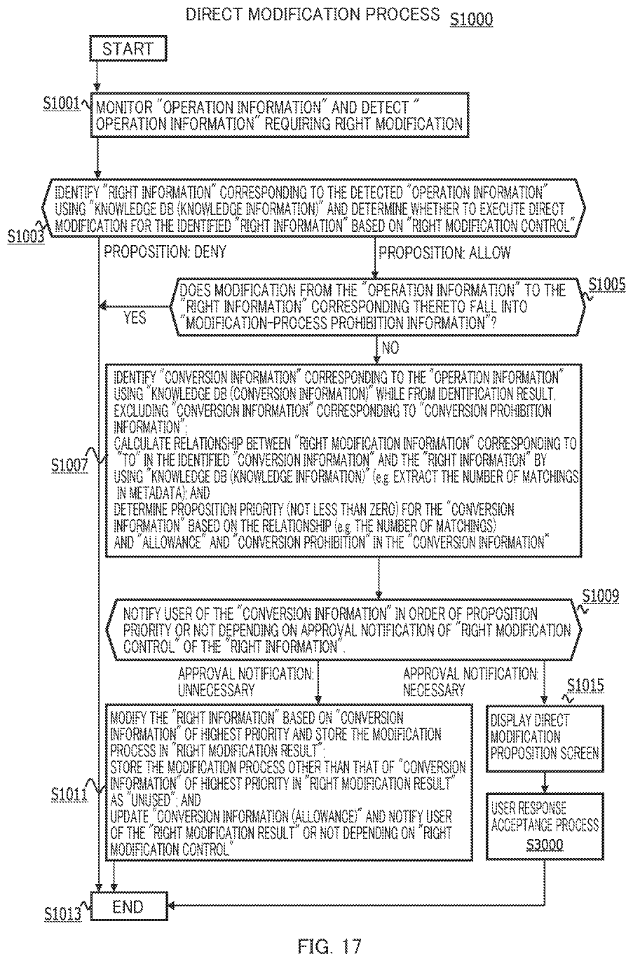

FIG. 17 is a flowchart for explaining an example of the direct modification process s1000. The direct modification process s1000 is repeatedly executed after the start of the application execution process s3, for example, at a predetermined time, at predetermined time intervals, or at timings specified by the user or administrator.

First, the direct modification part 1030 of the system management apparatus 100 detects creation or update of the operation information 2040 (s1001).

The direct modification part 1030 identifies based on the knowledge information 2200, right information 2020 (direct modification target right information) that is information on an access right recorded as error information in the operation information 2040 detected in s1001. The direct modification part 1030 then determines based on the right modification control information 2120, whether processing of direct modification for the specified direct modification target right information can be executed (s1003).

Specifically, the direct modification part 1030 refers to the knowledge information 2200 and acquires the right information 2020 included in Metadata 2202 of the record with Number 2201 set to the operation information 2040 identified in s1001 to identify the direct modification target right information. The direct modification part 1030 then refers to the right modification control information 2120 and determines whether Proposition 21231 of Direct Modification 2123 of the record with Target Right Information 2122 set to the acquired right information 2020 is “allow”.

When processing of direct modification cannot be executed (Proposition: “deny” in s1003), the direct modification process s1000 ends (s1013). When processing of direct modification can be executed (Proposition: “allow” in s1003), the direct modification part 1030 executes processing in s1005.

In s1005, the direct modification part 1030 confirms based on the modification process prohibition information 2220 whether direct modification for the direct modification target right information identified in s1003 constitutes grounds for exclusion for which direct modification is not allowed.

Specifically, the direct modification part 1030 refers to the modification process prohibition information 2220 and determines whether the modification process prohibition information 2220 includes a record (direct modification target right information) in which User 2222 is set to the present user, Pre-modification Information 2223 is set to the operation information 2040 detected in s1001, and Post-modification Information 2224 is set to the right information 2020 that is included in Metadata 2202 and is acquired in s1003.

When the direct modification for the right information 2020 constitutes grounds for exclusion for which direct modification is not allowed (Yes in S1005), the direct modification process s1000 ends (s1013). When the direct modification for the right information 2020 does not constitute grounds for exclusion for which direct modification is not allowed (No in S1005), the direct modification part 1030 executes processing in s1007.

In s1007, based on the conversion information 2300 and conversion prohibition information 2210, the direct modification part 1030 identifies all the conversion patterns (hereinafter, referred to as direct modification applicable conversion patterns) that are applicable to direct modification for the direct modification target right information, except conversion patterns to be excluded. The direct modification part 1030 then identifies the strength of the relationship between the right information 2020 before and after conversion based on each direct modification applicable conversion pattern with reference to the knowledge information 2200 and thereby prioritizes the direct modification applicable conversion patterns based on the knowledge information 2200.

Specifically, first, the direct modification part 1030 refers to the conversion information 2300 and identifies all the records (2300A1 and 2300A1a) in which Pre-conversion Information 2302 is set to the operation information 2040 detected in s1001, Post-conversion Information 2303 is set to the right information 2020 (right modification information 2310) that is included in Metadata 2202 of the knowledge information 2200 and is acquired in s1003. The direct modification part 1030 acquires Number 2301 of each of the identified records (direct modification applicable conversion patterns). In this process, the direct modification part 1030 refers to the conversion prohibition information 2210 and checks records in which User 2212 is set to the present user and Conversion Information 2213 is set to the content of any acquired Number 2301, thus excluding a conversion pattern (conversion information) to be excluded.

The direct modification part 1030 acquires the right modification information 2310 (right information 2020 after conversion) indicated by Post-conversion Information 2303 of each of the identified records of the conversion information 2300. With reference to the knowledge information 2200, the direct modification part 1030 identifies attribute information (first attribute information) in Metadata 2202 of the record with Number 2201 set to the acquired right modification information 2310. On the other hand, the direct modification part 1030 acquires the right information 2020 (direct modification target right information) that is included in Metadata 2202 of the knowledge information 2200 and is identified in s1003. With reference to the knowledge information 2200, the direct modification part 1030 identifies the attribute information (second attribute information) in Metadata 2202 of the record with Number 2201 set to the acquired right information 2020 (direct modification target right information). The direct modification part 1030 prioritizes the identified direct modification applicable conversion patterns in descending order of similarity (the number of matchings in attribute information) between the identified first attribute information and second attribute information.

In this prioritization, the direct modification part 1030 may raise or lower the priority of each direct modification applicable conversion pattern depending on the number of inputs in Allowance 2304 or Conversion Prohibition 2305 of the conversion information 2300 (for example, a conversion pattern with a greater number in Allowance 2304 is given higher priority while a conversion pattern with a greater number in Conversion Prohibition 2305 is given lower priority).

Next, the direct modification part 1030 determines whether to make an approval notification for direct modification with each conversion pattern identified in s1007 (s1009). Specifically, the direct modification part 1030 refers to the right modification control information 2120 and determines whether Approval Notification 21232 of Direct Modification 2123 of the record with Target Right Information 2122 set to the right information 2020 (direct modification target right information) that is included in Metadata 2202 and is acquired in s1003 is set to “necessary”.

In the case of making an approval notification (Approval Notification: “necessary” in s1009), the direct modification part 1030 executes processing in s1015. In the case of not making an approval notification (Approval Notification: “unnecessary” in s1009), the direct modification part 1030 executes processing in s1011.

In s1011, the direct modification part 1030 selects the highest-priority conversion pattern among all the direct modification applicable conversion patterns identified in s1007 and performs direct modification for the direct modification target right information based on the selected conversion pattern. The direct modification part 1030 then records the content thereof in the right modification result information 2130. The direct modification part 1030 also records in the right modification result information 2130, information on the conversion patterns not selected. The direct modification process s1000 thus ends (s1013).

Specifically, the direct modification part 1030 refers to the conversion information 2300 and performs direct modification for the content of the direct modification target right information acquired in s1003 in accordance with the content (Pre-conversion Information 2302, Post-conversion Information 2303) of the record concerning the conversion pattern given the highest priority in s1007 among the records with Number 2301 acquired in s1007.

The direct modification part 1030 creates a new record in the right modification result information 2130 and in the new record, sets Pre-conversion Information 2133 to the operation information 2040 detected in s1001; Conversion Information 2134, the highest-priority conversion pattern (conversion information); Post-conversion Information 2135, the content (the right information 2020 after modification) of the right modification information 2310 of the record of the conversion information 2300 concerning the highest priority conversion pattern (conversion information); and Modification Process 2136, “direct modification”.

The direct modification part 1030 creates a new record in the right modification result information 2130 and in the new record, sets Pre-conversion Information 2133 to the operation information 2040 detected in s1001; Conversion Information 2134, a conversion pattern (conversion information) other than the highest-priority conversion pattern (conversion information); Post-conversion Information 2135, the content (the right information 2020 after conversion based on the conversion information 2300 not selected) of the right modification information 2310 of the record of the conversion information 2300 concerning the conversion pattern other than the highest-priority conversion pattern (conversion information); and Modification Process 2136, “unused”.

The direct modification part 1030 increments by one, the value of Allowance 2304 of the record of the conversion information concerning the highest-priority conversion pattern (conversion information) in the conversion information 2300.

With reference to the right modification control information 2120, when Result Notification 21233 of Direct Modification 2123 of the record with Target Right Information 2122 set to the right information 2020 (direct modification target right information) that is included in Metadata 2022 and is acquired in s1003 is “necessary”, the direct modification part 1030 sends information representing the content of direct modification to the user system 110 indicated in Notification Recipient 21234 of the same record. The user system 110 displays this information on the screen.

On the other hand, in s1015, the input-output part 1010 displays a screen (a direct modification proposition screen) that shows all the direct modification applicable conversion patterns identified in s1007 for proposition to the user. The direct modification part 1030 then executes a user response acceptance process s3000 (described in detail later). The direct modification process s1000 then ends (s1013).

### (Direct Modification Proposition Screen)

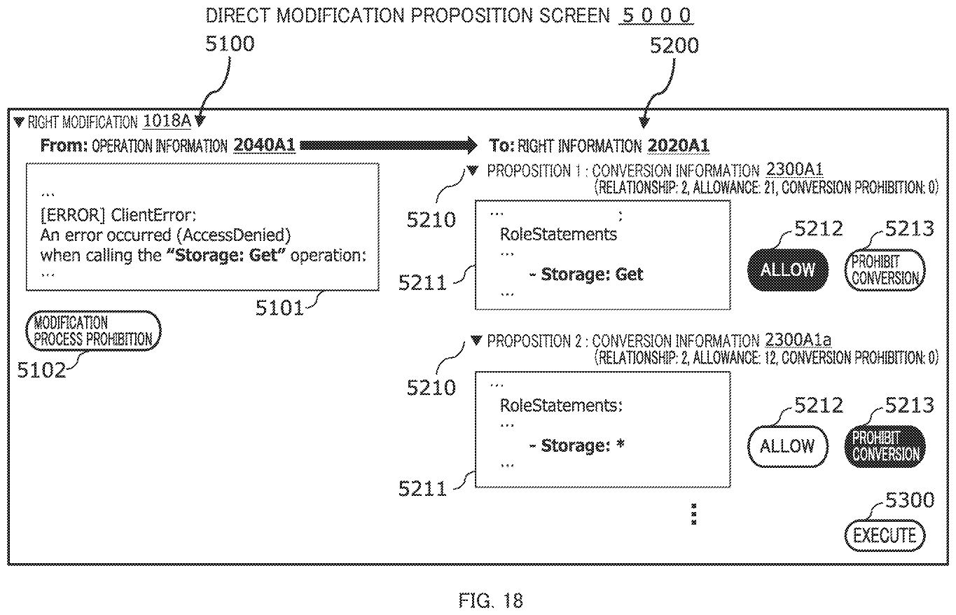

FIG. 18 is a diagram illustrating an example of a direct modification proposition screen 5000. The direct modification proposition screen 5000 includes: an operation information display field 5100; a modification proposition display field 5200 in which the content of one or more sets of conversion information 2300 is displayed in order of priority; and an execution specifying field 5300.

The operation information display field 5100 includes: an operation information display section 5101 that displays the operation information 2040; and a process prohibition specifying field 5102 that accepts from the present user, an input (a user modification-process prohibition input) not to allow modification for the right information 2020 identified by the operation information 2040 to be executed for the present user.

The modification proposition display field 5200 includes a basic information display field 5210, a post-modification right information display field 5211, a user allowance field 5212, and a user conversion prohibition field 5213 for each set of conversion information 2300. The basic information display field 5210 displays: the strength of the relationship (the number of matchings in attribute information or the like) between the right information 2020 before and after conversion based on the conversion information 2300; and the total number of past user allowance inputs and the total number of past user conversion prohibition inputs concerning the conversion of interest. The post-modification right information display field 5211 displays the content of right information 2020 after conversion based on the conversion information 2300. The user allowance field 5212 accepts a user allowance input from the present user. The user conversion prohibition field 5213 accepts a user conversion prohibition input from the present user. The post-modification right information display field 5211 can accept a user modification input from the present user as further modification for the right information 2020 after conversion.

The execution specifying field 5300 accepts from the present user, an input to fix the matters specified in the process prohibition specifying field 5102, user allowance field 5212, and user conversion prohibition field 5213 and execute direct conversion.

### <Indirect Modification Process>

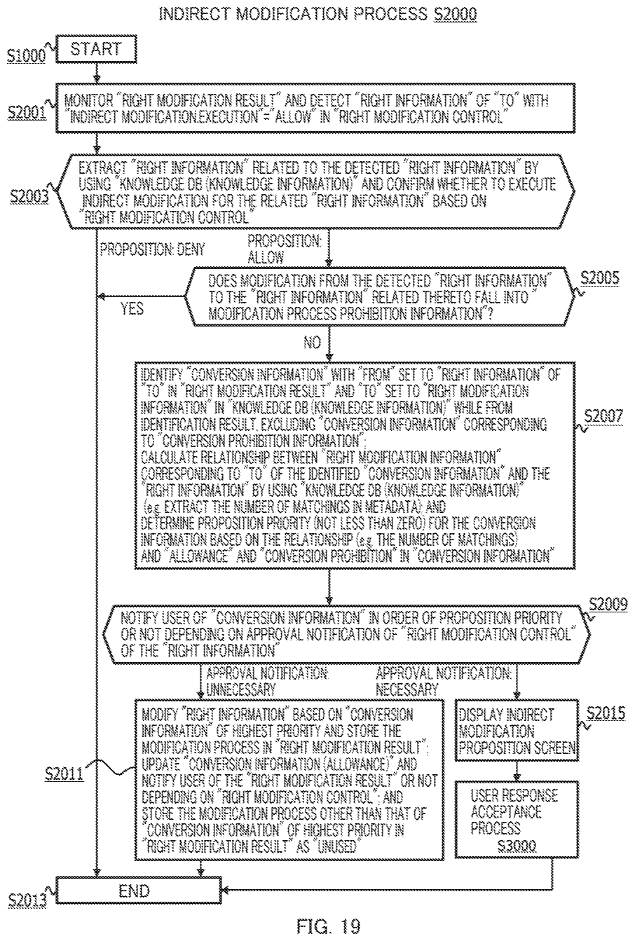

FIG. 19 is a flowchart for explaining an example of an indirect modification process S2000. The indirect modification process S2000 is repeatedly executed after the start of the application execution process s3, for example, at a predetermined time, at predetermined time intervals, or at timings specified by the user or administrator.

First, the indirect modification part 1040 of the access right management apparatus 1000 detects direct modification for right information 2020 and confirms whether indirect modification can be executed for the right information 2020 (hereinafter, referred to as indirect modification target right information) that is detected and subjected to direct conversion (s2001).

Specifically, the indirect modification part 1040 refers to the right modification result information 2130 and when detecting a new record with Modification Process 2136 being “direct modification”, acquires the content (indirect modification target right information) of Post-conversion Information 2135 (specifically, the right information 2020) of the record. The indirect modification part 1040 confirms whether Execution 21241 of Indirect Modification 2124 of the record of the right modification control information 2120 with Target Right Information 2122 set to the content of the acquired Post-conversion Information 2135 is “allow”.

The indirect modification part 1040 then extracts, based on the knowledge information 2200, the right information 2020 (hereinafter, referred to as related right information) that is related to the indirect modification target right information acquired in s2001. The indirect modification part 1040 determines based on the right modification control information 2120 whether the processing of indirect modification for the extracted related right information can be executed (s2003).

Specifically, with reference to the knowledge information 2200, the indirect modification part 1040 acquires the attribute information in Metadata 2202 of the record in which Number 2201 is set to the content (indirect modification target right information) of Post-conversion Information 2135 of the right modification result information 2130 acquired in s2001. The indirect modification part 1040 refers to the knowledge information 2200 and identifies a record which includes attribute information similar to the acquired attribute information and in which Number 2201 is set to any right information 2020 to extract the right information 2020 (related right information) indicated by that Number 2201 (a record of right information 2020 with the same user and program, for example) (B and C for A in 2201, for example). The indirect modification part 1040, with reference to the right modification control information 2120, determines whether Proposition 21242 of Indirect Modification 2124 of the record with Target Right Information 2122 set to the content (the indirect modification target right information) of Post-conversion Information 2135 acquired in s2001 is “allow”.

When processing of indirect modification cannot be executed (Proposition: “deny” in s2003), the indirect modification process S2000 ends (s2013). When processing of indirect modification can be executed (Proposition: “allow” in s2003), the indirect modification part 1040 executes processing in s2005.

In s2005, the indirect modification part 1040 confirms based on the modification process prohibition information 2220, whether indirect modification for the indirect modification target right information identified in s2003 constitutes grounds for exclusion for which modification is not allowed.

Specifically, the indirect modification part 1040, with reference to the modification process prohibition information 2220, determines whether the modification process prohibition information 2220 includes a record in which User 2222 is set to the present user; Pre-modification Information 2223 is set to the content (indirect modification target right information) of Post-conversion Information 2135 of the right modification result information 2130 that is acquired in s2001; and Post-modification Information 2224 is set to the right information 2020 (related right information) in Metadata 2202 of the knowledge information 2200 that is extracted in s2001.

When indirect modification for the indirect modification target right information constitutes grounds for exclusion for which modification is not allowed (Yes in S2005), the indirect modification process S2000 ends (s2013). When indirect modification for the indirect modification target right information does not constitute grounds for exclusion for which modification is not allowed (No in S2005), the indirect modification part 1040 executes processing in s2007.

In s2007, based on the conversion information 2300 and conversion prohibition information 2210, the indirect modification part 1040 identifies all the conversion patterns (hereinafter, referred to as indirect modification applicable conversion patterns) that are applicable to indirect modification for the indirect modification target right information, except conversion patterns to be excluded. The indirect modification part 1040, with reference to the knowledge information 2200, identifies the strength of the relationship between sets of right information 2020 to prioritize the indirect modification applicable conversion patterns based on the knowledge information 2200.

Specifically, with reference to the conversion information 2300, the indirect modification part 1040 identifies Post-conversion Information 2303 of the record of the conversion information 2300 with Number 2301 set to Conversion Information 2134 of the record of the right modification result information 2130 that is detected in s2001, that is, identifies previous direct modification, and identifies all other records of the conversion information 2300 in which Pre-conversion Information 2302 is set to the identified Post-conversion Information 2303 together with Number 2301 thereof (the indirect modification applicable conversion patterns corresponding to the direct modification). In this process, the indirect modification part 1040, with reference to the conversion prohibition information 2210, checks a record in which User 2212 is set to the present user and Conversion Information 2213 is set to the content (the indirect modification applicable conversion pattern) of the identified Number 2301, thus excluding the indirect modification applicable conversion pattern to be excluded.

Next, with reference to the conversion information 2300, the indirect modification part 1040 acquires the right modification information 2310 (right information 2020 after conversion) indicated by Post-conversion Information 2303 of the record in which Number 2301 is set to each of the identified indirect modification applicable conversion patterns. With reference to the knowledge information 2200, the indirect modification part 1040 acquires a set of attribute information in Metadata 2202 of the record with Number 2201 set to the right information 2020 in the acquired right modification information 2310. On the other hand, the indirect modification part 1040 acquires the right information 2020 (indirect modification target right information) as the content of Post-conversion Information 2135 of the right modification result information 2130 that is acquired in s2001. The indirect modification part 1040, with reference to the knowledge information 2200, acquires a set of attribute information in Metadata 2202 of the record with Number 2201 set to the acquired right information 2020. The indirect modification part 1040 prioritizes the identified indirect modification applicable conversion patterns in descending order of similarity between the acquired sets of attribute information (the number of matchings in attribute information).

In this prioritization, the indirect modification part 1040 may raise or lower the priority of each indirect modification applicable conversion pattern depending on the number of inputs in Allowance 2304 or Conversion Prohibition 2305 of the conversion information 2300 (a conversion pattern with a greater number of inputs in Allowance 2304 is given higher priority while a conversion pattern with a greater number of inputs in Conversion Prohibition 2305 is given lower priority, for example).

Next, the indirect modification part 1040 determines whether to make an approval notification concerning indirect modification for the right information 2020 based on the conversion patterns identified in s2007 (s2009). Specifically, with reference to the right modification control information 2120, the indirect modification part 1040 determines whether Approval Notification 21243 of Indirect Modification 2124 of the record with Target Right Information 2122 set to the right information 2020 (indirect modification target right information) in Metadata 2202 that is acquired from the knowledge information 2200 in s2003 is set to “necessary”.

In the case of making an approval notification (Approval Notification: “necessary” in s2009), the indirect modification part 1040 executes processing in s2015. In the case of not making an approval notification (Approval Notification: “unnecessary” in s2009), the indirect modification part 1040 executes processing in s2011.

In s2011, the indirect modification part 1040 selects the highest-priority conversion pattern among all the indirect modification applicable conversion patterns identified in s2007 and performs indirect conversion for the indirect modification target right information based on the selected conversion pattern. The indirect modification part 1040 then records the content thereof in the right modification result information 2130. The indirect modification part 1040 also records information on the other conversion patterns in the right modification result information 2130. The indirect modification process S2000 then ends (s2013).

Specifically, with reference to the conversion information 2300, the indirect modification part 1040 performs indirect modification for the content (indirect modification target right information) of Post-conversion Information 2135 of the right modification result information 2130 acquired in s2001 in accordance with the content (Pre-conversion Information 2302, Post-conversion Information 2303) of a record concerning the indirect modification applicable conversion pattern given the highest priority in s2007 among the records with Number 2301 (the conversion pattern) identified in s2007.

The indirect modification part 1040 creates a new record in the right modification result information 2130 and in the new record, sets Pre-conversion Information 2133 to the content (indirect modification target right information) of Post-conversion Information 2135 of the right modification result information 2130 acquired in s2001; Conversion Information 2134, the highest-priority conversion pattern (conversion information); Post-conversion Information 2135, the content (right information 2020 after modification) of the right modification information 2310 of the record of the conversion information concerning the highest priority conversion pattern (conversion information); and Modification Process 2136, “indirect modification”.

The indirect modification part 1040 creates a new record in the right modification result information 2130 and in the new record, sets Pre-conversion Information 2133 to the content (indirect modification target right information) of Post-conversion Information 2135 of the right modification result information 2130 acquired in s2001; Conversion Information 2134, a conversion pattern (conversion information) other than the highest-priority conversion pattern (conversion information); Post-conversion Information 2135, the content of the right modification information 2310 of the record of the conversion information 2300 concerning the conversion pattern (conversion information) other than the highest priority conversion pattern (conversion information); and Modification Process 2136, “unused”.

The indirect modification part 1040 increments by one, the value of Allowance 2304 of the record of the conversion information concerning the highest-priority conversion pattern (conversion information) in the conversion information 2300.

With reference to the right modification control information 2120, when Result Notification 21244 of Indirect Modification 2124 of the record with Target Right Information 2122 set to the content (indirect modification target right information) of Post-conversion Information 2135 of the right modification result information 2130 that is acquired in s2001 is “necessary”, the indirect modification part 1040 sends information representing the content of indirect modification to the user system 110 indicated by Notification Recipient 21245 of the same record. The user system 110 displays this information on the screen.

On the other hand, in s2015, the input-output part 1010 displays a screen (an indirect modification proposition screen) presenting all the indirect modification applicable conversion patterns (conversion information) identified in s2007 for proposition to the user. The indirect modification part 1040 then executes the user response acceptance process s3000 (described in detail later). The indirect modification process S2000 then ends (s2013).

### (Indirect Modification Proposition Screen)

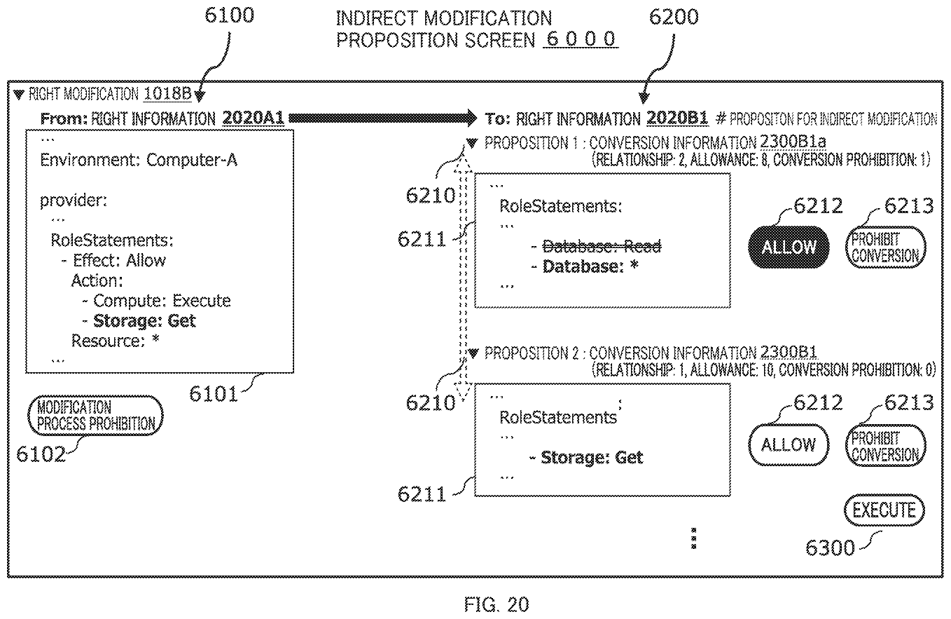

FIG. 20 is a diagram illustrating an example of an indirect modification proposition screen 6000. The indirect modification proposition screen 6000 includes: a pre-modification right information display field 6100; a modification proposition display field 6200 in which the contents of one or more sets of conversion information 2300 are displayed in order of priority; and an execution specifying field 6300.

The pre-modification right information display field 6100 includes a pre-conversion information display section 6101 that displays the right information 2020, and a process prohibition specifying field 6102 that accepts from the present user, an input (the user modification-process prohibition input) to not allow modification for the right information 2020 to be executed for the present user.

The modification proposition display field 6200 includes a basic information display field 6210, a post-modification right information display field 6211, a user allowance field 6212, and a user conversion prohibition field 6213 for each set of conversion information 2300. The basic information display field 6210 displays: the strength of the relationship (the number of matchings in attribute information or the like) between the sets of right information 2020 before and after conversion based on the conversion information 2300 of interest; and the total numbers of past user allowance inputs and past user conversion prohibition inputs concerning the conversion of interest. The post-modification right information display field 6211 displays the content of the right information 2020 after conversion. The user allowance field 6212 accepts a user allowance input from the present user. The user conversion prohibition field 6213 accepts a user conversion prohibition input from the present user. The post-modification right information display field 6211 can accept a user modification input from the present user as further modification for the right information 2020 after conversion.

The execution specifying field 6300 accepts from the present user, an input to fix the specified matters in the process prohibition specifying field 6102, user allowance field 6212, and user conversion prohibition field 6213 and execute indirect conversion.

### <User Response Acceptance Process>

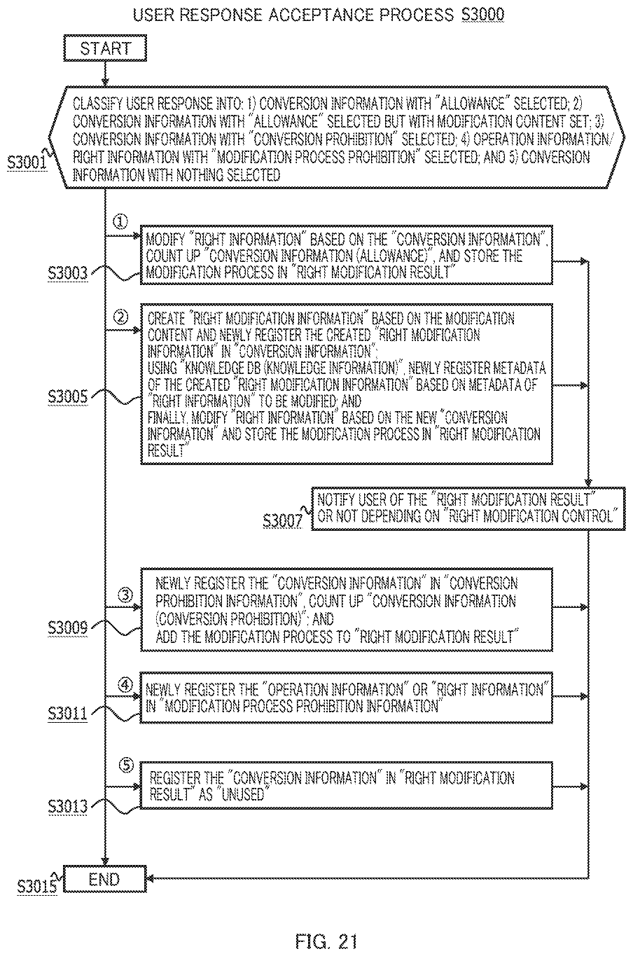

FIG. 21 is a flowchart for explaining an example of the user response acceptance process s3000.

The input-output part 1010 identifies which one of the following conversion patterns the set of information inputted from the user in the direct or indirect modification proposition screen 5000 or 6000 falls into: 1) a direct or indirect modification applicable conversion pattern for which the user allowance input is made (hereinafter, referred to as user allowed conversion information), 2) a direct or indirect modification applicable conversion pattern for which the user allowance input is made and the user modification input is made (hereinafter, referred to as user allowed and modified conversion information), 3) a direct or indirect modification applicable conversion pattern for which the user conversion prohibition input is made (hereinafter, referred to as user prohibited conversion information), 4) a direct or indirect modification applicable conversion pattern for which a user process-prohibition input is made (hereinafter, referred to as user process-prohibition conversion information), and 5) another direct or indirect modification applicable conversion pattern (conversion information 2300 for which nothing was selected by the user, hereinafter, referred to as none-selected conversion information) (s3001).

Specifically, the input-output part 1010 identifies each set of conversion information based on selection in the process prohibition specifying field 5102, user allowance field 5212, and user conversion prohibition field 5213 in the direct modification proposition screen 5000. Alternatively, the input-output part 1010 identifies each set of conversion information based on selection in the process prohibition specifying field 6102, user allowance field 6212, and user conversion prohibition field 6213 in the indirect modification proposition screen 6000.

The input-output part 1010 executes processing in s3003 to s3013 in the following manner depending on the type of conversion information identified in s3001.

For the user allowed conversion information, the input-output part 1010 modifies right information 2020 based on the user allowed conversion information in s3003. The processing in s3007 is then performed.

Specifically, in accordance with the content (Pre-conversion Information 2302, Post-conversion Information 2303) of a record concerning the user allowed conversion information among the records of the conversion information 2300 with Number 2301 acquired in s1007 or s2007, the direct or indirect modification part 1030 or 1040 performs direct or indirect modification for the content (direct modification target right information) of the right information 2020 in Metadata 2202 of the knowledge information 2200 that is acquired in 31003 or the content (indirect modification target right information) of Post-conversion Information 2135 of the right modification result information 2130 that is acquired in s2001.

The input-output part 1010 increments by one, the value of Allowance 2304 of the record concerning the user allowed conversion information in the conversion information 2300 to update the conversion information 2300. Furthermore, the input-output part 1010 creates a new record in the right modification result information 2130 and respectively sets Pre-conversion Information 2133, Conversion Information 2134, and Post-conversion Information 2135 to Pre-conversion Information 2302, Number 2301, and Post-conversion Information 2303 of the record of the conversion information 2300 used to modify the right information 2020. The input-output part 1010 sets Modification Process 2136 to “direct conversion” or “indirect conversion” (addition of the modification for right information 2020 to the history).

For the user allowed and modified conversion information, in s3005, the input-output part 1010 creates the right modification information 2310 representing the user allowed and modified conversion information and registers the same in the conversion information 2300. The input-output part 1010 registers the attribute information of this right modification information 2310 in the knowledge information 2200. The input-output part 1010 modifies the right information 2020 based on the registered conversion information 2300 and adds the content of modification in the right modification result information 2130. The processing in s3007 is then performed.

Specifically, the input-output part 1010 creates right information 2020 as new right modification information 2310 by reflecting the combination (user allowed and modified conversion information) of the content of a record concerning the user-allowed conversion information among the records of the conversion information 2300 concerning Number 2301 (conversion pattern) acquired in s1007 or s2007 and the information modified by the user in the post-modification right information display fields 5211 or 6211, on the content (direct modification target right information) of the right information 2020 acquired in s1003 or the content (indirect modification target right information) of Post-conversion Information 2135 of the right modification result information 2130 acquired in s2001. The input-output part 1010 creates a new record in the conversion information 2300 and sets Pre-conversion Information 2302 of the created record to the right information 2020 before conversion while setting Post-conversion Information 2303 to the created right information 2020.

The input-output part 1010 creates a new record in the knowledge information 2200 and sets Number 2201 of the created record to the created new right modification information 2310 while setting Metadata 2202 to attribute information (for example, the user, program, execution part, and operation information) of the right information 2020 before conversion.

In accordance with the content (Pre-conversion Information 2302, Post-conversion Information 2303) of the newly created record of the conversion information 2300, the input-output part 1010 performs direct or indirect modification for the content (direct modification target right information) of the right information 2020 acquired in s1003 or the content (indirect modification target right information) of Post-conversion Information 2135 of the right modification result information 2130 that is acquired in s2001.

Furthermore, the input-output part 1010 creates a new record in the right modification result information 2130 and respectively sets Pre-conversion Information 2133, Conversion Information 2134, and Post-conversion information 2135 of the created record to Pre-conversion Information 2302, Number 2301, and Post-conversion Information 2303 of the record of the conversion information 2300 used to modify the right information 2020 while setting Modification Process 2136 to “direct modification” or “indirect modification”.

In s3007, the input-output part 1010 notifies the user of the modification of the right information 2020 in s3003 or s3005. The processing in s3015 is then performed.

Specifically, when Result Notification 21233 of Direct Modification 2123 or Result Notification 21244 of Indirect Modification 2124 of the record of the right modification control information 2120 in which Target Right Information 2122 is set to the content (direct modification target right information) of the right information 2020 acquired in s1003 or the content (indirect modification target right information) of Post-conversion Information 2135 of the right modification result information 2130 acquired in s2001 is “necessary”, the input-output part 1010 notifies the user system 110 indicated by the notification recipient 21234 or 21245 of the same record that the right information 2020 was modified.

For the user prohibited conversion information, in s3009, the input-output part 1010 registers the user prohibited conversion information in the conversion prohibition information 2210 and sets the current user conversion prohibition input in the conversion information 2300 while setting the user conversion prohibition input in the right modification result information 2130. The user response acceptance process s3000 then ends (s3015).

Specifically, the input-output part 1010 sets User 2212 of a new record of the conversion prohibition information 2210 to the information on the present user and sets Conversion Information 2213 to the user prohibited conversion information. The input-output part 1010 increments by one, the value of Allowance 2304 of the record concerning the user prohibited conversion information in the conversion information 2300. In the new record of the right modification result information 2130, the input-output part 1010 sets Pre-conversion Information 2133 to the content (direct modification target right information) of the right information 2020 acquired in s1403 or the content (indirect modification target right information) of Post-conversion Information 2135 of the right modification result information 2130 acquired in s2001; Conversion Information 2134, the conversion information 2300 concerning the user prohibited conversion information; Post-conversion Information 2135, the content (right information 2020 after conversion) of the right modification information 2310 of the record of the knowledge information 2200 identified in s1007 or s2007; and Modification Process 2136, “prohibited”.

For the user process-prohibition conversion information, in s3011, the input-output part 1010 registers information concerning user process prohibition in the modification process prohibition information 2220. Then the user response acceptance process s3000 ends (s3015).

Specifically, the input-output part 1010 sets User 2222 of the modification process prohibition information 2220 to the present user; Pre-modification Information 2223, the operation information 2040 detected in s1001 or the right information 2020 detected in s200.1; and Post-modification Information 2224, the content (right information 2020 after conversion) of the right modification information 2310 of the record of the knowledge information 2200 identified in s1007 or s2007.

In s3013, in the right modification result information 2130, the input-output part 1010 registers information indicating that the conversion information is not selected. Then the user response acceptance process s3000 ends (s3015).

Specifically, in the new record of the right modification result information 2130, the input-output part 1010 sets Pre-conversion Information 2133 to the content (direct modification target right information) of the right information 2020 acquired in s1403 or the content (indirect modification target right information) of Post-conversion Information 2135 of the right modification result information 2130 acquired in s2001; Conversion Information 2134, the conversion information 2300 concerning the none-selected conversion information; Post-conversion Information 2135, the content (right information 2020 after conversion) of the right modification information 2310 of the record of the knowledge information 2200 identified in s1007 or s2007; and Modification Process 2136, “unused”.

### (Right Modification Result Management Screen)

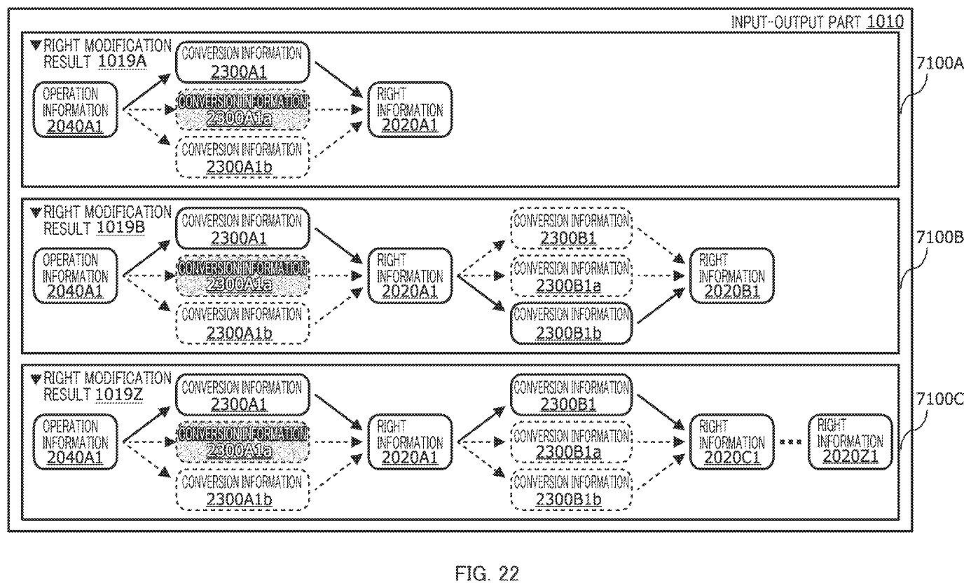

FIG. 22 is a diagram illustrating an example of a right modification result management screen 7000 as a screen showing the content of the right modification result information 2130, which is displayed by the access right management apparatus 1000. The right modification result management screen 7000 includes display fields 7100 (7100A, 7100B, and 7100C) for each modification history of right information 2020.

The modification history display field 7100A shows direct modification based on the operation information 2040A1, indicating that the modified right information 2020A1 was created by direct modification based on the conversion information 2300A1a for which a user allowance input was made, among three sets of conversion information 2300A1, 2300A1a, and 2300A1b proposed in the direct modification proposition screen 5000. For example, the three sets of conversion information 2300A1, 2300A1a, and 2300A1b are conversion information 2300 for which a user allowance input was made, conversion information 2300 for which a user prohibition input was made, and conversion information 2300 for which nothing was selected, respectively.

The display field 7100B shows direct modification based on the operation information 2040A1 and indirect modification based on the same, indicating that the modified right information 2020A1 was created by direct modification based on the conversion information 2300A1a for which a user allowance input was made, among the three sets of conversion information 2300A1, 2300A1a, and 2300A1b proposed in the direct modification proposition screen 5000 and the modified right information 2020B1 was created by indirect modification based on the conversion information 2300B1b for which a user allowance input was made, among three sets of conversion information 2300B1, 2300B1a, and 2300B1b proposed in the indirect modification proposition screen 6000.

The display field 7100C shows direct modification based on the operation information 2040A1 and indirect modification performed multiple times based on the same, indicating that the modified right information 2020A1 was created by direct modification based on the conversion information 2300A1a for which a user allowance input was made, among the three sets of conversion information 2300A1, 2300A1a, and 2300A1b proposed in the direct modification proposition screen 5000; the modified right information 2020C1 was created by indirect modification based on the conversion information 2300B1a for which a user allowance input was made, among three sets of conversion information 2300B1, 2300B1a, and 2300B1b proposed in the indirect modification proposition screen 6000; and furthermore modified right information 2020Z1 was created.

### <Reuse Process>

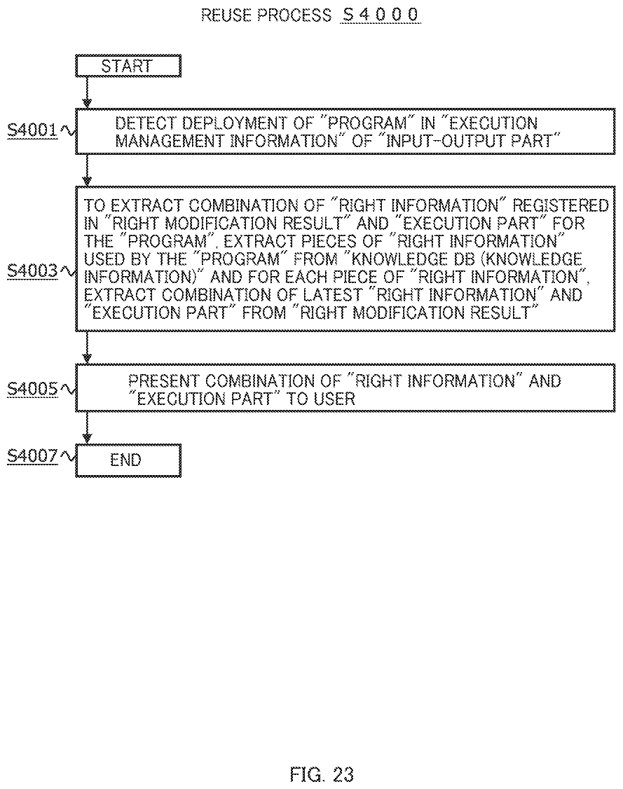

FIG. 23 is a flowchart for explaining an example of the reuse process s4000.

When the reuse part 1050 detects that the user specified the program 2030 in the program specifying fields 3101, 3201 of the first screen 3100 (s4001), the reuse part 1050 extracts a combination of the right information 2020 and execution part 1020 corresponding to the specified program 2030 (s4003).

Specifically, the reuse part 1050 acquires Metadata 2202 of the record concerning the specified program 2030 from the knowledge information 2200 and acquires all the combinations of the execution part 1020 and operation information 2040 corresponding thereto from the acquired metadata 2202. With reference to the right modification result information 2130, the reuse part 1050 acquires Post-conversion Information 2135 of the record with Pre-conversion Information 2133 set to the acquired operation information 2040. Then, with reference to the right modification result information 2130, the reuse part 1050 identifies the latest record with Post-conversion Information 2135 set to the content (right information 2020) of the acquired Post-conversion Information 2135 and acquires the identified right information 2020.

The reuse part 1050 displays the combinations of the right information 2020 and execution part 1020 extracted in s4003 in the right information proposition fields 3106 and 3204 of the execution management screen 3000.

As described above, when the direct modification target right information indicating an access right necessary for the first user system 110A to access an application (the program 2030) is modified, the access right management apparatus 1000 of the embodiment identifies based on the knowledge information 2200, indirect modification target right information that indicates an access right necessary for the second user system 110C to access the application and has a relationship with the direct modification target right information. The access right management apparatus 1000 converts the content of modification of the direct modification target right information into a content of modification corresponding to the indirect modification target right information and performs indirect modification for the indirect modification target right information using the content of modification obtained by the conversion.

Thus, when the right information 2020 for a certain user system 110 is modified, the access right management apparatus 1000 of the embodiment converts the content of modification for the right information 2020 of another user system 110 having a relationship with the certain user system 110 and reflects the content of modification obtained by the conversion on the right information 2020 of the another user system 110.

According to the access right management apparatus 1000 of the embodiment, therefore, it is possible to properly place access rights of plural systems executing an application.

Furthermore, the access right management apparatus 1000 of the embodiment identifies the indirect modification target right information based on the knowledge information 2200; identifies the conversion information 2300 used to convert the content of modification for the direct modification target right information to a content of modification corresponding to the indirect modification target right information for modification of the indirect modification target right information with the content of modification obtained by the conversion, the conversion information 2300 being configured to convert the content of modification for right information 2020 to a content of modification in another format; and displays information on the conversion information 2300.

By displaying conversion information 2300 used to modify the indirect modification target right information in such a manner, the user is able to know how the indirect modification will be executed or was executed.

Still furthermore, the access right management apparatus 1000 of the embodiment determines based on the determination information of Execution 21241 of Indirect Modification 2124 of the right modification control information 2120, whether modification for indirect modification target right information based on conversion information 2300 can be executed. When determining that modification for the indirect modification target right information can be executed, the access right management apparatus 1000 accepts from the user, an input representing whether to confirm execution of the modification (proposition to the user). When accepting an input to confirm execution of the modification, the access right management apparatus 1000 modifies the indirect modification target right information.

Thus, the access right management apparatus 1000 of the embodiment determines whether modification (indirect modification) for indirect modification target right information can be executed and when determining to execute the modification, accepts a confirmation input from the user. This enhances operation flexibility in applying indirect modification.

Still furthermore, the access right management apparatus 1000 of the embodiment manages the history of the input representing whether to confirm execution of the modification for indirect modification target right information based on each set of conversion information 2300, by using Allowance 2304 of the conversion information 2300; based on the knowledge information 2200, identifies the strength of the relationship between each set of conversion information 2300 and the indirect modification target right information; based on the identified strength of each relationship and the history of the confirmation regarding the modification, determines the priority of each set of conversion information 2300; and based on the determined priorities, displays the sets of conversion information 2300 for use in modifying the indirect modification target right information.

Thus, the sets of conversion information 2300 are displayed in accordance with the priorities determined based on the history of user confirmation for each set of conversion information 2300 and the relationship between the conversion information 2300 and indirect modification target right information. It is therefore possible to present more proper conversion information 2300 to the user in a more understandable way.

Still furthermore, the access right management apparatus 1000 of the embodiment accepts from the user, selection of an input: to currently modify the indirect modification target right information using the content of modification based on the conversion information 2300, to not modify the same currently, or to not modify the same currently and in future and displays the history of the selection accepted in past.

The user is thereby able to check the policy that the user himself/herself employed before and use the same for future operation of indirect modification.

Still furthermore, the access right management apparatus 1000 of the embodiment accepts specification of an application from the user and, when the application is specified, displays the program that can access the specified application and the access right information based on the right modification result information 2130 and knowledge information 2200.

The user is thereby able to know the execution part and access right information corresponding to the specified application based on the history of past modification for access right information.

Still furthermore, when a conversion rule for modifying indirect modification target right information is specified, the access right management apparatus 1000 of the embodiment determines based on the conversion prohibition information 2210 and modification process prohibition information 2220 whether to modify the indirect modification target right information. The access right management apparatus 1000 modifies the indirect modification target right information only when determining to modify the indirect modification target right information.

By providing such an exceptional rule that does not allow conversion for indirect modification target right information, the user is able to prevent indirect modification target right information from being incorrectly rewritten to interfere with operation of the application (for example, when the content of indirect modification target right information based on the first access right information is not reliable).

Still furthermore, the access right management apparatus 1000 of the embodiment determines based on the determination information of Execution 21141 of Direct Modification 2123 of the right modification control information 2120 whether modification for direct modification target right information based on an initial conversion rule (conversion information 2300 for direct modification) can be executed. When determining that modification for the direct modification target right information can be executed, the access right management apparatus 1000 accepts from the user, an input representing whether to confirm execution of the modification. When accepting an input to confirm execution of the modification, the access right management apparatus 1000 modifies the direct modification target right information.

Thus, the access right management apparatus 1000 of the embodiment determines whether to execute modification (direct modification) for direct modification target right information and when determining to execute the direct modification, accepts a confirmation input from the user. This enhances operation flexibility in applying direct modification.

The access right management apparatus 1000 of the embodiment manages the history of the input representing whether to confirm execution of the modification for direct modification target right information based on each set of conversion information 2300, by using Allowance 2304 of the conversion information 2300; based on the knowledge information 2200, identifies the strength of the relationship between each set of conversion information 2300 and the direct modification target right information; based on the identified strength of the relationship and the history of the confirmation regarding the modification, determines the priority of each set of conversion information 2300; and based on the determined priorities, displays the sets of conversion information 2300 for use in modifying the direct modification target right information.

Thus, the sets of conversion information 2300 are displayed in accordance with the priorities determined based on the history of user confirmation for each set of conversion information 2300 and the relationship between the conversion information 2300 and direct modification target right information. It is therefore possible to present more proper conversion information 2300 to the user in a more understandable way.

Still furthermore, when an initial conversion rule for modifying direct modification target right information is identified, the access right management apparatus 1000 of the embodiment determines based on the conversion prohibition information 2210 and modification process prohibition information 2220 whether to modify the direct modification target right information. The access right management apparatus 1000 modifies the direct modification target right information only when determining to modify the direct modification target right information.

By providing such an exceptional rule that does not allow conversion for direct modification target right information, the user is able to prevent direct modification target right information from being incorrectly rewritten to interfere with operation of an application (for example, when the content of error information in the operation information 2040 is not reliable).

The present invention is not limited to the aforementioned embodiment and can be implemented using any constituent elements without departing from the spirit of the invention. The embodiment and modifications described above are just examples, and the present invention is not limited to the contents thereof as long as the features of the invention are not impaired. Although the above description includes various embodiments and modifications, the invention is not limited to the contents thereof. The other modes that can be implemented within the scope of technical ideas of the invention are also within the scope of the invention.

Part of each function included in each apparatus of the embodiment may be provided for another apparatus, or functions included in different apparatuses may be provided in the same apparatus.

The method of identifying the relationship (connection or similarly) between components based on the knowledge information 2200 (the matching method) is not limited to the method described in the embodiment. For example, the relationship between components is identified based on the commonality of the number, types, or pattern of the pieces of attribute information included in the components.

Furthermore, the configuration of the function part of the access right management apparatus 1000 described in the embodiment is just an example. For example, the function part may be partially built in another function part, or plural function parts may be configured as a single function part.

What is claimed is:

1. An access right management apparatus, comprising:
a processor and a memory; and
an indirect modification part configured to:
when first access right information is modified with a first modification content, the first access right information indicating an access right necessary for a first system to access an application, identify based on a predetermined database, second access right information indicating an access right necessary for a second system to access the application and having a relationship with the first access right information;
convert the first modification content of the first access right information to a second modification content corresponding to the second access right information; and
modify the identified second access right information with the second modification content.

2. The access right management apparatus according to claim 1, further comprising:
a data storage part configured to store attribute information of the first access right information and the second access right information as the predetermined database; and
an input-output part, wherein
the indirect modification part
identifies the second access right information based on the attribute information in the predetermined database; and
identifies a conversion rule used to convert the first modification content of the first access right information to the second modification content corresponding to the second access right information for modification of the identified second access right information with the second modification content, the conversion rule converting the first modification content of the first access right information to the second modification content in a different format, and
the input-output part displays information on the identified conversion rule.

3. The access right management apparatus according to claim 2, wherein the input-output part
determines based on predetermined determination information whether modification for the second access right information based on the conversion rule can be executed,
when determining that the modification for the second access right information can be executed, accepts from a user an input representing whether to confirm execution of the modification, and
when the accepted input confirms execution of the modification, modifies the identified second access right information.

4. The access right management apparatus according to claim 3, wherein the indirect modification part
acquires a plurality of the conversion rules,
manages a history of the input representing whether to confirm execution of the modification for the second access right information based on each of the plurality of conversion rules,
based on the database storing the attribute information of the first and the second access right information, identifies the strength of a relationship between each of the plurality of conversion rules and the second access right information, and
determines priorities for the plurality of conversion rules based on the identified strength of each relationship and the history of the input representing whether to confirm execution of the modification for the second access right information, and
based on the determined priorities, the input-output part displays the conversion rules for use in modifying the second access right information.

5. The access right management apparatus according to claim 2, wherein
the input-output part
accepts from the user, selection of an input to currently modify the second access right information with the second modification content based on the conversion rule, to not currently modify the same, or to not modify the same currently and in future, and
displays a history of the selection accepted in past.

6. The access right management apparatus according to claim 2, wherein
the application is accessible through at least one predetermined program, and
the data storage part stores a history of modification for the first and the second access right information and information on the program for accessing the application,
the access right management apparatus comprising:
a reuse part configured to accept specification of the application from the user and when the application is specified, displays the program that is able to access the specified application and access right information based on the stored history of modification and information on the program.

7. The access right management apparatus according to claim 2, wherein
the conversion rule includes a first conversion rule prohibited from being used,
the data storage part stores prohibition information storing the first conversion rule and access right information prohibited from being converted based on any of the conversion rules, and
the indirect modification part, when the conversion rule to modify the second access right information is identified, determines based on the prohibition information whether to modify the second access right information and only when determining to modify the second access right information, modifies the second access right information.

8. The access right management apparatus according to claim 2, further comprising
a direct modification part configured to modify the first access right information, wherein
the data storage part stores an initial conversion rule that defines the first modification content of the first access right information, and
the input-output part determines based on predetermined determination information whether modification for the first access right information based on the initial conversion rule can be executed and when determining that the modification for the first access right information can be executed, modifies the first access right information.

9. The access right management apparatus according to claim 8, wherein the direct modification part
acquires a plurality of the initial conversion rules,
manages a history of an input representing whether to confirm execution of modification for the first access right information based on each of the plurality of initial conversion rules,
based on the database storing the attribute information of the first and the second access right information, identifies the strength of a relationship between each of the plurality of initial conversion rules and the first access right information, and
determines priorities for the plurality of initial conversion rules based on the identified strength of each relationship and the history of the input representing whether to confirm execution of modification for the first access right information, and
based on the determined priorities, the input-output part displays the initial conversion rules for use in modifying the first access right information.

10. The access right management apparatus according to claim 8, wherein
the plurality of initial conversion rules include a first initial conversion rule prohibited from being used,
the data storage part stores exclusion information storing information on the first initial conversion rule and access right information prohibited from being converted with any of the initial conversion rules, and
when the initial conversion rule to modify the first access right information is selected, the direct modification part determines based on the exclusion information whether to modify the first access right information, and
only when determining to modify the first access right information, modifies the first access right information.

11. An access right management method, implemented by an information processing apparatus comprising:
executing an indirect modification process to:
when first access right information is modified with a first modification content, the first access right information indicating an access right necessary for a first system to access an application, identify based on a predetermined database, second access right information indicating an access right necessary for a second system to access the application and having a relationship with the first access right information;
convert the first modification content of the first access right information to a second modification content corresponding to the second access right information; and
modify the identified second access right information with the second modification content.
